(19) United States
(12) Patent Application Publication
(10) Pub. No.: US 2023/0144400 A1
(43) Pub. Date: May 11, 2023

(54) POSITIONING PANEL

(71) Applicant: Vasily Vladimirovich SMIRNOV, Perm Kral, g. Perm (RU)

(72) Inventor: Vasily Vladimirovich SMIRNOV, Perm Kral, g. Perm (RU)

(21) Appl. No.: 17/624,106

(22) PCT Filed: Mar. 25, 2020
(86) PCT No.: PCT/RU2020/000159

§ 371 Date: Dec. 30, 2021

(30) Foreign Application Priority Data
Jul. 5, 2019 (RU) 2019121437

(51) Int. Cl. B25H 3/00; B25H 3/04; B65D 85/28

(52) U.S. Cl. CPC B25H 3/003; B25H 3/04; B65D 85/28

(57) ABSTRACT

A positioning panel comprises polygonal apertures having an n number of edges, wherein the angle of inclination of the edges, i.e. the angle between a plane perpendicular to the upper and lower surfaces of the panel and the plane of the edge of a polygonal through-aperture, lies in a range of (0.1-4°), and the inner surface of the polygonal through-apertures tapers towards the base. The panel has conical through-apertures, which are smaller in diameter than the polygonal through-apertures. The polygonal through-apertures are arranged such as to alternate with the smaller sized conical through-apertures in accordance with the condition that 2≤S≤14 mm, where S is the minimum distance between the polygonal through-apertures, measured along the upper front surface of the panel. The technical result is improved functional efficiency and expanded functional capabilities.

### FIELD OF INVENTION

This invention relates to a device for fixing and storing hand tools, interchangeable heads, interchangeable tips, also called tool bits, carriers and other similar devices, as well as household items like stationery.

The panel can be used in everyday life (garage, bathroom, hallway, desk, workbench, cradle in cases, boxes, wall panel near or by the desk to fasten tools, stationery and any household items).

### BACKGROUND

There are various known devices for fixing hand tools to organize their storage and improve their usability. For example, according to Patent Documents RU 2414342 (published 20 Mar. 2011), RU 2302361 (published 10 Jul. 2007), RU 108334 (published 20 Sep. 2011), RU 50522 (published 20 Jan. 2006), KR 1998024247 (published 25 Jul. 1998), FR 2555090 (published 24 May 1985), TWM 473909 (published 11 Mar. 2017), CN 202241233 (published 30 May 2012). However, they are not versatile enough and are inconvenient to use. Very often, such devices are designed for a specific set of tools. Therefore, there is a need for a more versatile tool-storage device that can accommodate a variety of different tools and accessories.

Also there is a known (positioning) panel (platform) for hand tools, tool bits and interchangeable heads according to Patent Document U.S. Pat. No. 8,505,720 B2 (published 13 Aug. 2013), as well as positioning panels for hand tools according to Patent Documents U.S. Pat. No. 9,193,063 B2 (published 24 Nov. 2015) and U.S. Pat. No. 8,371,444 B1 (published 12 Feb. 2013), which have common features with the positioning panel described in U.S. Pat. No. 8,505,720 B2. The positioning panel for hand tools includes a panel and at least one tool holder, constituting a tool-storage kit. The panel has a number of through-holes to mount the holders, the holes generally have a rectangular shape. The holder has a tool-holding element and a cylindrical shank made as one piece therewith. The shank has a collar at the top and a plate-like platform with recesses at the lower end, which adjoins the bottom surface of the panel when the holder is installed in its hole. Each hole in the panel has two grooves on two opposite side walls that mate with a collar on the shank. Each hole has protrusions on two opposite sides perpendicular to the grooved sides, which mate with the recesses on the plate-like platform of the holder shank. On the lower side of the panel, between each hole, there is a holder-positioning element which has a central protrusion and two lateral protrusions. The lateral protrusions extend from the central protrusion in the direction of two corresponding holes that are located diagonally to each other. When the holder is installed in the hole, the plate-like platform, sliding with its recesses along the protrusions in the hole, engages with the lower side of the panel, while the shank collar abuts against the grooves in the hole. The holder is fixed by turning it in the hole, while the holder-positioning element on the lower side of the panel allows to rotate the holder only in one direction by 90° during its installation and in the opposite direction during its removal and re-installation, if necessary. There can be different embodiments of the tool-holding element of the holder, for example, it can be made as an elongated plate or cuboid (cubic, generally closer to a rectangular parallelepiped). Holders with plate-like tool-holding elements are used in pairs, for example, to hold tool handles. Holders with cuboid tool-holding elements are used to hold interchangeable heads that are mounted on the cuboid element. Tool bits can be inserted directly into the panel holes. Such a tool storage kit, including a positioning pad and tool holders with different shapes of tool-holding elements, is more convenient since it can hold not only tool bits, but also other tools or tool accessories. The panel can be placed in a toolbox or tool cart, or it can be wall-mounted. It is known that workplace organization and streamlining are one of the most important challenges at any company. Including the organization of storage of necessary tools, which allows to locate and use them quickly and easily. In this case, tools should be in plain sight, so that they can be conveniently taken, used and easily returned to their place. The disadvantage of the above device is that it is not functional and convenient enough. Tool holders are installed in one position, which limits the use of the tool-positioning panel, tools can only be arranged in a certain order, it is impossible to fasten large irregularly shaped bench tools on it, for example, pliers, dies, wrenches and similar tools. On the other hand, it is impossible to fasten small-diameter or small-size tools, as well as tools without handles or small tool accessories, for example, hex angle screwdrivers, long thin drills, on such a tool-positioning panel using the proposed holders. Therefore, the device has a limited number of assembly and application options for various types of tools and accessories. Such a panel is inconvenient to use, since each time the holders are installed in a certain way, the holder shank has to be inserted into the hole and turned to be fixed, which requires skill. The same skill is required to remove the holder. The panel is also inconvenient as not all tools and accessories can be fastened on it. So they will have to be stored and searched for elsewhere. Due to a smooth surface of the plate-like tool-holding element, the tool may slip out of the holders, for example, when the positioning panel is carried in a tool box. In addition, the panel and the holder have a complex shape, which makes them difficult to manufacture.

There is also a known carrier arrangement for storing and/or transporting and/or cleaning dishware or other items according to Patent Document US 2017/0027411 (published 2 Feb. 2017), which can also be used to store tools. The arrangement has a carrier plate with a number of rectangular, in particular square, holes and tool carriers with a tool-holding element and at least one octagonal shank to be installed in a through-hole of the carrier plate, which is made as one piece with the tool-holding element. In this case, the through-holes of the carrier plate have a bead on the upper surface, and the octagonal shank has latching tongues on four sides that engage with the said bead. To fasten the tool holder, its octagonal shank shall be inserted into the through-hole up to the stop and turned to be fixed (as in the above positioning panel described in Patent Document U.S. Pat. No. 8,505,720 B2). It has the same disadvantages as the positioning panel for hand tools, tool bits and interchangeable heads described above in Patent Document U.S. Pat. No. 8,505,720 B2.

There were attempts to solve this problem by creating a device chosen as a prior art.

The closest analog to the patentable solution is (Patent N2663024, B25H 3/00 published 1 Aug. 2018) a tool-storage device, which has a positioning panel with a number of through-holes and tool holders with at least one octagonal shank with equal facets to be installed in a through-hole of the positioning panel, made as one piece with the tool-holding element. Through-holes of the positioning panel are octagonal, and facets have equal length and width; there is a central groove in the shank body and a collar (shoulder) at the base of the shank body; there is at least one groove in the body of at least one tool holder. Through-holes in the positioning panel are chamfered on the upper and lower surfaces of the positioning panel.

This technical solution is chosen as the closest analog of the claimed invention.

The prior art has a positioning panel with a number of octagonal through-holes, and tool holders with at least one octagonal shank to be installed in a through-hole of the positioning panel, which is made as one piece with the tool-holding element.

Due to the octagonal shape of through-holes and shanks, tools can be positioned linearly, perpendicularly or at an angle of 45° (diagonally) on the panel, since this shape allows to install single-shank holders in holes with a 45° pitch and double-shank holders—with a 90° pitch. Single-shank holders can be panel mounted in eight positions, double-shank holders in four positions. The panels can be connected to each other with fasteners in the form of several octagonal elements protruding from the panel side and having a groove along their axis, and with corresponding extreme through-holes on the opposite side of the panel, which have a vertical slit along the panel side. The shape and size of the protruding octagonal elements correspond to the through-holes in the panel.

The disadvantage is that the holder in the prior art panel can only be installed to diagonally, i.e. at the angles of 45° and 90°. Users of the panel with eight multifaceted through-holes faced with difficulties to hold and fix some irregularly curved tools on the panel, such as pincers and pliers. It became necessary to develop a new shape of a multifaceted through-hole, which would ensure the rotation of a holder shank at a smaller angle than 45° and 90°.

### SUMMARY

The objective of the invention is to eliminate the above disadvantages and create a positioning panel—a device with the possibility to use it jointly with various types of fasteners (holder shanks) and with different tools in a single technical design.

The technical result consists in improving the usability and functionality of the positioning panel. The above technical result is achieved by the possibility of a relatively quick and efficient changeover of the panel (tool fasteners) to use with different tools. This is possible by expanding the positioning range with additional angles: 5.625°, 11.25° and 22.5°, ensuring a rational use of the positioning panel area up to 100%.

The technical result is achieved in that the positioning panel contains a top surface (front) and a bottom surface (base) with a number of multifaceted through-holes in the panel body; opposite facets of multifaceted through-holes are equal, and multifaceted through-holes are arranged in rows in the panel body; there are chamfers on the top and bottom surfaces of the panel at the location of multifaceted through-holes; according to the invention, the number of facets is multiple of four, but more than eight, and adjacent facets have different width, and the chamfer slope angle, i.e. angle between the plane perpendicular to the top and bottom surfaces of the panel, and the chamfer plane, is within (20-50°), and the facet slope angle, i.e. angle between the plane perpendicular to the top and bottom surfaces of the panel, and the plane of the multifaceted through-hole facet, is within (0.1-4°); and the inner surface of multifaceted through-holes narrows towards the base; and the panel contains conical through-holes smaller than multifaceted through-holes; and multifaceted through-holes alternate with smaller conical through-holes, subject to the condition of 2≤S≤14 mm, where S is a minimum distance between the multifaceted through-holes, measured along the top front surface of the panel. In addition, one of adjacent facets a is no more than 4.91 mm wide, and other facet b is no more than 0.3 mm wide. In addition, multifaceted through-holes have pitch L within (8-20) mm, where pitch L is a distance between the centers of multifaceted through-holes. In addition, multifaceted through-holes on the front top surface of the panel have diameter D within (6-10) mm, where D is a diameter of a circumscribing circle along the vertices of a polygon formed by facets of the multifaceted through-hole at the points where a chamfer on the front top surface of the panel interfaces with facets of the multifaceted through-hole.

In addition, smaller facets of the inner surface of multifaceted through-holes can be concave or corners in the multifaceted through-hole can be rounded.

In addition, smaller facets of the inner surface of multifaceted through-holes are concave with a radius of rounding of no less than 0.1 mm.

In addition, smaller conical through-holes widen towards the base.

In addition, conical through-holes have a diameter of no more than 3.5 mm.

In addition, the positioning panel is made of ABS plastic.

The creation of the proposed invention—a new design of a positioning panel (hereinafter—the panel) with multifaceted through-holes, and the number of facets of multifaceted through-holes shall simultaneously meet two conditions: it shall be multiple of four, but be no more than eight—in combination with other design features provides a wider range of positioning angles as compared to the prior art, since it allows more precise positioning of various holder shanks in faceted through-holes of the panel.

The proposed device differs from the closest prior art described above in that the number of facets of multifaceted through-holes shall simultaneously meet two conditions: it shall be multiple of four, but be no more than eight.

The proposed embodiment of the positioning panel, namely, the shape of multifaceted through-holes with the number of facets multiple of four, but no more than eight, allows to install (position) the holder shanks at different angles: 5.625°, 11.25°, 22.5°, 45° and 90°.

In the prior art panel, single-shank holders can only be positioned at the angles of 45° and 90°.

In contrast to the functionality of the prior art panel, single-shank holders can be mounted on the panel in 64 positions (at 22.5°—16 positions, at 11.25°—32 positions, at 5.625°—64 positions). In the prior art, single-shank holders can be mounted on the panel only in eight positions. A secure fixation of various tools, parts and non-standard curved items in the prior art panel is not possible. For the holders to better grip a tool of such a complex shape, it became necessary to create a panel and a shape of multifaceted through-holes, which would allow more turns of holder shanks without additional instruments for maximum user convenience.

To this end, the positioning panel in the proposed technical solution has prismatic multifaceted through-holes.

For convenience, a multifaceted through-hole (with side walls) in the panel can be conventionally divided into three parts:

the first top part is a conical cylinder narrowing from the hole face towards the base;

the second or middle part of the hole is prismatic narrowing towards the base;

the third bottom part is a conical cylinder widening towards the base.

The above positioning panel and multifaceted through-holes in the panel improve the usability and functionality of the panel, allowing to securely fasten various tools and items.

Such embodiment of the positioning panel and multifaceted through-holes allows to use holders of various shapes, which shall have a shank. The shank is made as one piece with the tool-holding element of the holder. Shanks of various shapes are used for such multifaceted through-holes of the positioning panel: with one groove in the shank and without a central groove in the shank body, with a collar (shoulder) at the base of the shank body, with several grooves, with a cross-shaped groove, with ribs on the side surface of the shank, etc. Shanks are used regardless of the number of facets on it. Cylindrical shanks are applicable for the proposed panel if the holder has more than two shanks.

Shanks of various holders can be inserted in the proposed panel: with a plate-like tool-holding element, with a ribbed, wavy surface, etc. The outer surface of the holder and the holding element can be rough or have a different pattern. For convenience, holders with a plate-like element, a ribbed, wavy surface are normally used in pairs. The shank rotation angles provided by the proposed panel with multifaceted through-holes are relevant for a single-shank holder. Holder shanks are positioned in two mutually perpendicular axes.

If the holder has one shank, it is advisable to make it with facets, since the shank needs to be positioned in the panel and rotated to a certain degree. The number of facets of one shank is multiple of four, but is no more than eight, and adjacent facets have different width, mainly 16 or 32 facets. Holders can have 2 shanks, which can be made with facets or cylindrical. Holders can have 3 shanks, which can be made with facets or cylindrical. It is advisable to make double-shank or triple-shank holders cylindrical to simplify the manufacture of a mold for the holder.

Since the design of the panel allows positioning the holders with more options of angles, this guarantees a more secure fixation of various items and tools as compared to the prior art. Therefore, the new storage system panel can be used in tool cases and special vehicles. In such cases, operating conditions are more severe due to vibration, requiring a more secure fastening of tools, in contrast to stationary workstations. In this case, a wider range of angles provided by the proposed panel design allows to fasten the same tools more securely with the same number of holders as in the prior art. This allows using this positioning panel in storage systems in specialized applications, which improves the functionality of the panel.

In the proposed technical solution, the chamfer slope angle of 20 to 50° in multifaceted through-holes, as well as the facet slope angle of multifaceted through-holes within (0.1-4°) ensure a reliable fastening, entry and exit of the holder shank with optimal force into/from the faceted through-holes of the panel.

In other words, optimal performance of the panel and the possibility of its easy changeover start with a 20° chamfer slope angle. This allows using it jointly with various types of fasteners (holder shanks) of tools and items, ensuring the application of the positioning panel together with different tools and items in a single technical design.

Multifaceted through-holes in the positioning panel have pitch L, wall thickness S and diameter D. Pitch L is a distance between the centers of multifaceted through-holes. Wall thickness S is a minimum distance between the multifaceted through-holes. Diameter D of a multifaceted through-hole on the front top surface of the panel is a diameter of a circumscribing circle along the vertices of a polygon formed by facets of the multifaceted through-hole at the points where a chamfer on the front top surface of the panel interfaces with facets of the multifaceted through-hole. The embodiment of multifaceted through-holes with pitch L within (8-20) mm, diameter D within (6-10) mm, and the embodiment of the positioning panel with wall thickness S between the multifaceted through-holes within (2-14) mm have been determined experimentally. The difference between pitch L determined by a distance between the centers of holes, and diameter D of multifaceted through-holes is equal to wall thickness S between the multifaceted through-holes: S=L−D. Wall thickness S between the multifaceted through-holes is determined by the ratio: 2≤S≤14.

It is advisable to make larger multifaceted through-holes with diameter D within 6-10 mm, with a pitch within (8-20) mm.

With pitch L less than 8 mm for any panel size, the number of larger multifaceted through-holes with diameter D of 6 to 10 mm increases to the extent that such a panel is virtually impossible to manufacture, since the minimum distance between the multifaceted through-holes—wall thickness S— will become thinner, and in the panel production, a thinner wall will complicate the production process due to material plasticity. The plasticity of material used to make the panel will not allow casting (molding) the panel with such thin walls, since it will lead to a higher rejection rate of the panel. In addition, increasing the number of holes will reduce the rigidity of the panel itself, and the holder will be able to withstand a lesser load. If a multifaceted through-hole is reduced, i.e. diameter D of multifaceted through-holes becomes less than 6 mm, the holder shank (stem) will decrease accordingly. Reducing the size of the shank—the holder stem leads to a lesser load on the holder. This significantly reduces strength (reliability of fastening).

If diameter D of the multifaceted through-hole is more than 10 mm, the elasticity of the holder shank (stem) will be reduced to zero, i.e. the stem will be very rigid.

If diameter D of the faceted through-hole is more than 10 mm, the ability of the holder shank (stem) material to deform is reduced to zero, i.e. the stem will be very rigid. Therefore, it is not practicable to make the shank-stem more than 10 mm long. The shank-stem is made of polyamide. It follows from the material characteristics that shear modulus is

G=1.9-2 GPa=1900-2000 MPa=1900-2000N/mm².

The displacement of the shank can be calculated based on the calculations and principles for selecting an interference fit (M. N. Ruditsyn Handbook on the Strength of Materials/M. N. Ruditsyn, P. Ya. Artemov, M. I. Lyuboshits—3rd Ed., revised. and add. Minsk:Higher School, 1970.—630, p. 27), subject to Section 3 of GOST 9550-81 “Plastics” (GOST 95 50-81 “Plastics. Methods for determining the elastic modulus of elongation, compression and bending”, effective date 1982-07-01) and (https://studfiles.net/miit/MSIS2/folder:25128/#4552228). Shear modulus G is a physical value that characterizes elastic properties of materials and their ability to resist shear deformations. It is theoretically determined by the ratio of shear stresses τ to shear angle θ. It is indicated by the Latin letter G, the unit of measurement is pascal [Pa] (gigapascal [GPa]).

In strength materials study, this modulus is used in shear, section and torsion calculations.

Since shear modulus G is directly proportional to the cross-sectional area of the shank body—force F application area, upon which the force has action:

$$G = \frac{{τ}_{xy}}{{γ}_{xy}} = \frac{F / A}{Δ x / ℓ} = \frac{F ℓ}{A Δ x} ,$$

where
τ=F/A are shear stresses;
θ is a shear angle;
F is a shear force;
A is a force F application area;
Δx is a shear value;
l is an element size (in this example—shank length),
Δx can be defined

$$Δ x = \frac{Fl}{G} : \frac{A}{1} = \frac{Fl}{GA} ,$$

There is a relationship between the shear modulus, Young's modulus and Poisson's ratio, through which shear modulus G is calculated. Shear modulus G is expressed in terms of elastic modulus E and Poisson's ratio μ. After that, the displacement of the shank-stem is determined.

$$G = \frac{E}{2 ( 1 + μ )} ,$$

where E is Young's modulus,
μ is Poisson's ratio.
For cast polymers, Young's modulus E and Poisson's ratio μ are in the range:
E=1500÷3000 MPa,
μ=0.37÷0.41.

Shear modulus G is calculated by mean parameters:

$$G = \frac{2000}{2 ( 1 + 0.4 )} = 714 MPa = 714 \frac{N}{mm 2} ,$$

We determine the load acting upon the connection of the shank and the chamfer. When the shank passes through the chamfers on the top and bottom surfaces of the panel at the location of the multifaceted through-hole, circumferential forces Fcir arise, which are directly proportional to force Fcir (axial force) of inserting the shank into the multifaceted through-hole of the panel through the chamfer slope angle. (https://studfiles.net/miit/MSIS2/folder:25128/#4552228).

The required force Fcir to insert the holder into the multifaceted through-hole of the panel is determined experimentally and is 157 N. For example, we select a chamfer slope angle of 20°, tgα=0.364.

$${F}_{OK} = \frac{{F}_{OC}}{tg α} = \frac{157 N}{0.364} = 431 N$$

The shank consists of two halves and each half is displaced and deformed. Let's calculate the displacement of the holder shank half, with a diameter of 8 mm. The shank length is limited by a panel height (depth) of 10 mm, so in the formula we use the shank length of 10 mm. Force application area A is determined using an automated CAD system:

$$Δ x = \frac{431 N \times 10 mm}{714 MPa \times 17 mm 2} = \frac{4310}{12138} = 0.25 mm .$$

This displacement Δx equal to 0.35 mm is sufficient to insert the holder in the multifaceted through-hole of the panel. The relationship between the components of deformations and stresses is called a generalized Hooke's law. With Δx equal to 0.35 mm, elastic deformations remain. This follows from Hooke's law: the elastic force is directly proportional to the displacement according to Hooke's law Fel=−kΔx. Coefficient k characterizes the rigidity of the sample and depends on its size and material. Shear modulus G is expressed in terms of tensile modulus E and Poisson's ratio μt. With a shank diameter of more than 10 mm, for example, 12 mm, all other things being equal, the displacement of the shank half is calculated in the same way as the above formula:

$$Δ x = \frac{431 \times 10}{714 \times 65} = \frac{4310}{46410} = 0.092 ( mm ) .$$

To install this shank, displacement Δx=0.092 mm is small.

Since the elastic force is directly proportional to the displacement according to Hooke's law Fel=−kΔx and since displacement Δx is very small, the elastic force of the shank is too small, this allows to conclude that a shank of such size cannot be used in the panel as it becomes very rigid.

Thus, pitch L of (8-20) mm is an optimal pitch of faceted through-holes with diameter D within (6-10) mm.

In addition, pitch L of (8-20) mm is an optimal pitch of multifaceted through-holes with diameter D within (6-10) mm for holder shanks, since each holder with a holding element has an elastic deformation zone that allows to cover (compensate for) each pitch of eight to twenty millimeters.

If pitch L is less than 8 mm, for example, 7 mm, larger multifaceted through-holes will be located every 7 mm, which is unusable in the panel in a storage system for various items, since the wall becomes thin, and wall thickness S becomes less than 2 mm.

With step L of more than 20 mm, wall thickness S between the multifaceted through-holes increases and the wall thickens. For example, with step L=20 mm and diameter D=6 mm, wall thickness S=14 mm. With S>14 mm, although the panel strength increases, its functionality decreases with this size—distance between the hooks-holders will grow. This leads to impossibility to fasten a screwdriver or a smaller part (or the same tool that was previously fastened) between the holders with such a pitch. With pitch L of more than 20 mm, the panel becomes unusable in a storage system for most conventional holders (systems), for most standard tools: screwdrivers, hammers, chisels, chippers, etc. With S>14 mm, it is impractical to use the panel also for the reason that a lot of material is required to manufacture the panel.

With pitch L=8 mm, the panel has a certain number (a certain density) of larger multifaceted through-holes with diameter D=6 mm, for example, when the panel size is 200*300 mm. With a panel thickness of 10 mm and pitch L in the range of 8-20 mm, the required panel rigidity is provided to fix holder shanks, which has been determined experimentally. This is also confirmed by the above calculation of shank displacement Δx and resulting elastic force determined by the formula:Fel=−kΔx.

With pitch L of more than 8 mm and D=6 mm, the number of multifaceted through-holes decreases. The panel becomes usable for larger tools and parts.

For example, the panel has pitch L=20 and D=10 mm. It can be used to store different household and industrial items of various shapes, in trucks, and for heavy tools. For example, it can be used to hold bottles, tubes and jars at the display booth, shampoos in the bathroom, i.e. for larger items.

It has been experimentally determined that when wall thickness S between the multifaceted through-holes is less than 2 mm, the panel loses its mechanical strength. All the above-mentioned features distinguishing it from the prior art allow to increase the versatility, functionality and usability of the device to store tools in comparison with the closest analog. An additional advantage is a simpler shape of the panel and holder shanks, which makes them easier to manufacture.

Smaller conical through-holes in the panel serve several purposes:
lighter structure of the panel itself;
saving of material;
possibility to avoid product shrinkage—the positioning panel during the panel manufacture, for example, by casting. If there were no smaller holes, the shrinkage of material plastic used to make the panel—would be visible in the form of irregularities of different depth and shape;
possibility of concealed fixing of the panel on the rear side to any surface, using self-tapping screws and rivets through the surface itself via holes. For example, the panel needs to be fastened to a stand—a lattice. These holes are pre-drilled in the surface if the surface is not perforated, then self-tapping screws can be screwed into the pre-drilled holes to mount the panel, which leads to a versatile use of the base. To this end, conical through-holes in the panel widen towards the base. In this case, no self-tapping screws or other fasteners are visible. The base is monolithic as a single matrix;
possibility to use the panel as a translucent decorative panel (to highlight the showcase, self-adhesive tape is glued via the rear side of the panel, with LEDs on it).

This improves the panel functionality. Most bolt screws, self-tapping screws and other fasteners are up to 3 mm. Based on this size, the dimensions of smaller conical through-holes in the panel are defined. If the panel had no smaller conical through-holes, the panel versatility would be reduced.

In particular case, the invention may have smaller facets rounded with a radius of at least 0.1 mm in the multifaceted through-holes.

In the prior art, the panel is made of conventional plastic—polypropylene. In the proposed invention, it is made of ABS plastic. When the prior art panel is used at a temperature above 35° C., the material plasticity effect occurs, which affects the fixation of holders. The fixation of holders is thus impaired. Also, partitions between the through-holes soften considerably when temperature rises above 35° C.

The full name of ABS plastic is acrylonitrile-butadiene-styrene copolymer (the name of the plastic is formed by the initial letters of the monomer names) (Chem 21.info Chemist's Handbook/Ed. by B. P. Nikolsky, L.: Chemistry, 1971). Plastic is made by copolymerizing styrene with acrylonitrile in the presence of butadiene rubber. The material can be any color and is highly transparent. ABS plastic is engineering plastic with many important Jo characteristics, such as high impact resistance, mechanical strength, rigidity and non-toxicity under normal conditions. Based on these properties, ABS plastic is much superior to even high-impact polystyrene, not to mention other types of plastics: polypropylene, polyethylene or PVC. Even under high mechanical stress (when hit with a sledgehammer), an ABS product deforms, but does not crack or disintegrate. The deformed area is easily and quickly restored. The same cannot be done with any other plastic, since it will simply disintegrate. The molecular weight of the substance can reach 180 thousand, exceeding the weight of other polymeric compounds by 4-9 times. At the same time, the weight of products made of ABS plastic is less in comparison with most models made of other materials. ABS plastic can withstand short-term heating up to 90-100° C. The maximum temperature of long-term operation is 75-80° C., it also retains its properties at negative temperatures down to −40° C. ABS plastic is suitable for electroplating, vacuum metallization, soldering of contacts; it is also highly weldable and recommended for precision casting. In addition, ABS plastic has high dimensional stability, is resistant to alkalis, lubricating oils, solutions of inorganic salts and acids, hydrocarbons, fats and gasoline. It also has low flammability. ABS plastic is non-toxic, safe, environmentally friendly and recyclable. Pure ABS is free of halogens and generally produces no persistent organic pollutants when incinerated.

Let's compare ABS plastic and polypropylene. An important indicator of impact resistance is Charpy V-notch impact energy (23° C.). For polypropylene, it is 12 kJ/m2, which points to high impact properties. However, this indicator of ABS plastic exceeds that of polypropylene by more than two times (up to 30 kJ/m2). This means that it can withstand an impact twice as strong as polypropylene can.

Frost resistance of polypropylene is also limited to −25 . . . −30° C. When cooled below this value, plastic becomes brittle. ABS plastic consistently resists stress at −40° C. However, polypropylene is noticeably superior to ABS plastic in terms of resistance to high temperatures. It can withstand temperatures up to 138° C., while ABS plastic loses strength at 118° C. But these temperature levels are hardly useful in household environment.

ABS plastic is harder, its Rockwell hardness is R116. Polypropylene hardness is R82. It is easier to cut, scratch and perforate. For example, if the panel is screwed on with a screwdriver, the panel will not crack in comparison with the prior art, since ABS plastic is harder and does not deform from mechanical damage. Tensile strength of polypropylene is 27 MPa, for ABS plastic this indicator reaches 50 MPa, i.e. almost twice as much.

In addition to the above, the bending modulus of elasticity of ABS plastic reaches up to 3000 MPa, of polypropylene up to 930 MPa. Polypropylene products are subject to significant deformations, and under heavy loads, a product made of such material can be simply crushed, while one made of ABS plastic will remain intact. Thus, the use of ABS plastic to make the panel improves the usability and functionality of the positioning panel.

The proposed technical solution has novelty, inventive step and industrial applicability, i.e. all criteria of an invention. The novelty of the technical solution and the inventive step are confirmed by the conducted patent research. The industrial applicability is based on the panel serviceability, as well as the fact that non-scarce materials such as ABS plastic and well-known technologies are used to manufacture the panel. The claimed technical solution of the tool-storage device can be implemented in industrial production environment using standard equipment and technologies. Standard materials are used for the manufacture.

### BRIEF DESCRIPTION OF THE DRAWINGS

The summary of the invention is explained below with the aid of drawings.

FIG. 1 shows a general view of the positioning panel in axonometric projection;

FIG. 2 shows the positioning panel, top view;

FIG. 3 shows the positioning panel, view A—a detail of the panel segment with pitch L, D, S;

FIG. 4 shows a top view of a multifaceted through-hole;

FIG. 5 shows the positioning panel; section B-B;

FIG. 6 shows the positioning panel, section B-B, a multifaceted through-hole narrowing towards the base, a conical through-hole widening towards the base;

FIG. 7 shows the positioning panel, section D-D;

FIG. 8-12 show different examples of installing shanks with a different number of facets and different shapes into multifaceted through-holes with rotation at different angles φ(examples of positioning the holder shanks at different angles): 5.625°, 11.25°, 22.5°, 45°, 90°, bottom view:

FIG. 8 shows an example of holder shank rotation at angle φ1=90°, bottom view;

FIG. 9 shows an example of holder shank rotation at angle φ2=45°, bottom view;

FIG. 10 shows an example of holder shank rotation at angle φ3=22.5°, bottom view;

FIG. 11 shows an example of holder shank rotation at angle φ4=11.25°, bottom view;

FIG. 12 shows an example of holder shank rotation at angle φ5=5.625°, bottom view;

FIGS. 13-15 show various examples of upper and lower chamfers with different slope angles:

FIG. 13 shows an example of upper and lower chamfers with slope angles α1=β1=24′;

FIG. 14 shows an example of upper and lower chamfers with slope angles α2 20°; β2=24′;

FIG. 15 shows an example of upper and lower chamfers with slope angles α3=β3=50°;

FIGS. 16-18 show various examples of inner surfaces of a multifaceted through-hole with different facet slope angles

FIG. 16 shows an example of a 2° facet slope angle of a multifaceted through-hole;

FIG. 17 shows an example of a 0° 6′ or 0.1° facet slope angle of a multifaceted through-hole;

FIG. 18 shows an example of a 3° 30 facet slope angle of a multifaceted through-hole;

FIG. 19 shows an example of the size and number of facets of a multifaceted through-hole, multiple of four, with n=12, D=6 mm, b=0.1 mm, a=2.91 mm;

FIG. 20 shows an example of the size and number of facets of a multifaceted through-hole, multiple of four, with n=16, D=6 mm, b=0.1 mm, a=2.2 mm;

FIG. 21 shows an example of the size and number of facets of a multifaceted through-hole, multiple of four, with n=24, D=6 mm, b=0.1 mm, a=1.46 mm;

FIG. 22 shows an example of the size and number of facets of a multifaceted through-hole, multiple of four, with n=32, D=6 mm, b=0.1 mm, a=1.07 mm;

FIG. 23 shows an example of the size and number of facets of a multifaceted through-hole, multiple of four, with n=64, D=6 mm, b=0.1 mm, a=0.49 mm;

FIG. 24 shows an example of the size and number of facets of a multifaceted through-hole, multiple of four, with n=128, D=6 mm, b=0.1 mm, a=0.4 mm;

FIG. 25 shows an example of the size and number of facets of a multifaceted through-hole, multiple of four, with n=12, D=8 mm, b=0.1 mm, a=3.91 mm;

FIG. 26 shows an example of the size and number of facets of a multifaceted through-hole, multiple of four, with n=16, D=8 mm, b=0.1 mm, a=2.97 mm;

FIG. 27 shows an example of the size and number of facets of a multifaceted through-hole, multiple of four, with n=24, D=8 mm, b=0.1 mm, a=1.97 mm;

FIG. 28 shows an example of the size and number of facets of a multifaceted through-hole, multiple of four, with n=32, D=8 mm, b=0.1 mm, a=1.46 mm;

FIG. 29 shows an example of the size and number of facets of a multifaceted through-hole, multiple of four, with n=64, D=8 mm, b=0.1 mm, a=0.68 mm;

FIG. 30 shows an example of the size and number of facets of a multifaceted through-hole, multiple of four, with n=128, D=6 mm, b=0.1 mm, a=0.29 mm;

FIG. 31 shows an example of the size and number of facets of a multifaceted through-hole, multiple of four, with n=12, D=10 mm, b=0.1 mm, a=4.91 mm;

FIG. 32 shows an example of the size and number of facets of a multifaceted through-hole, multiple of four, with n=16, D=10 mm, b=0.1 mm, a=3.73 mm;

FIG. 33 shows an example of the size and number of facets of a multifaceted through-hole, multiple of four, with n=24, D=10 mm, b=0.1 mm, a=2.49 mm;

FIG. 34 shows an example of the size and number of facets of a multifaceted through-hole, multiple of four, with n=32, D=10 mm, b=0.1 mm, a=1.85 mm;

FIG. 35 shows an example of the size and number of facets of a multifaceted through-hole, multiple of four, with n=64, D=10 mm, b=0.1 mm, a=0.88 mm;

FIG. 36 shows an example of the size and number of facets of a multifaceted through-hole, multiple of four, with n=128, D=10 mm, b=0.1 mm, a=0.39 mm;

FIG. 37 shows an example of the size and number of facets of a multifaceted through-hole, multiple of four, with n=12, D=6 mm, b=0.3 mm, a=2.74 mm;

FIG. 38 shows an example of the size and number of facets of a multifaceted through-hole, multiple of four, with n=16, D=6 mm, b=0.3 mm, a=2.02 mm;

FIG. 39 shows an example of the size and number of facets of a multifaceted through-hole, multiple of four, with n=24, D=6 mm, b=0.3 mm, a=1.26 mm;

FIG. 40 shows an example of the size and number of facets of a multifaceted through-hole, multiple of four, with n=32, D=6 mm, b=0.3 mm, a=0.88 mm;

FIG. 41 shows an example of the size and number of facets of a multifaceted through-hole, multiple of four, with n=64, D=6 mm, b=0.3 mm, a=0.31 mm;

FIG. 42 shows an example of the size and number of facets of a multifaceted through-hole, multiple of four, with n=12, D=8 mm, b=0.3 mm, a=3.74 mm;

FIG. 43 shows an example of the size and number of facets of a multifaceted through-hole, multiple of four, with n=16, D=8 mm, b=0.3 mm, a=2.78 mm;

FIG. 44 shows an example of the size and number of facets of a multifaceted through-hole, multiple of four, with n=24, D=8 mm, b=0.3 mm, a=1.78 mm;

FIG. 45 shows an example of the size and number of facets of a multifaceted through-hole, multiple of four, with n=32, D=8 mm, b=0.3 mm, a=1.27 mm;

FIG. 46 shows an example of the size and number of facets of a multifaceted through-hole, multiple of four, with n=64, D=8 mm, b=0.3 mm, a=0.49 mm;

FIG. 47 shows an example of the size and number of facets of a multifaceted through-hole, multiple of four, with n=128, D=8 mm, b=0.3 mm, a=0.09 mm;

FIG. 48 shows an example of the size and number of facets of a multifaceted through-hole, multiple of four, with n=12, D=10 mm, b=0.3 mm, a=4.74 mm;

FIG. 49 shows an example of the size and number of facets of a multifaceted through-hole, multiple of four, with n=16, D=10 mm, b=0.3 mm, a=3.55 mm;

FIG. 50 shows an example of the size and number of facets of a multifaceted through-hole, multiple of four, with n=24, D=10 mm, b=0.3 mm, a=2.3 mm;

FIG. 51 shows an example of the size and number of facets of a multifaceted through-hole, multiple of four, with n=32, D=10 mm, b=0.3 mm, a=1.66 mm;

FIG. 52 shows an example of the size and number of facets of a multifaceted through-hole, multiple of four, with n=64, D=10 mm, b=0.3 mm, a=0.68 mm;

FIG. 53 shows an example of the size and number of facets of a multifaceted through-hole, multiple of four, with n=128, D=10 mm, b=0.3 mm, a=0.19 mm;

FIG. 54 shows an example of the size and number of facets of a multifaceted through-hole, multiple of four, with n=12, D=6 mm, b=0.5 mm, a=2.57 mm;

FIG. 55 shows an example of the size and number of facets of a multifaceted through-hole, multiple of four, with n=16, D=6 mm, b=0.5 mm, a=1.83 mm;

FIG. 56 shows an example of the size and number of facets of a multifaceted through-hole, multiple of four, with n=24, D=6 mm, b=0.5 mm, a=1.07 mm;

FIG. 57 shows an example of the size and number of facets of a multifaceted through-hole, multiple of four, with n=32, D=6 mm, b=0.5 mm, a=0.68 mm;

FIG. 58 shows an example of the size and number of facets of a multifaceted through-hole, multiple of four, with n=64, D=6 mm, b=0.5 mm, a=0.09 mm;

FIG. 59 shows an example of the size and number of facets of a multifaceted through-hole, multiple of four, with n=12, D=8 mm, b=0.5 mm, a=3.57 mm;

FIG. 60 shows an example of the size and number of facets of a multifaceted through-hole, multiple of four, with n=16, D=8 mm, b=0.5 mm, a=2.6 mm;

FIG. 61 shows an example of the size and number of facets of a multifaceted through-hole, multiple of four, with n=24, D=8 mm, b=0.5 mm, a=1.59 mm;

FIG. 62 shows an example of the size and number of facets of a multifaceted through-hole, multiple of four, with n=32, D=8 mm, b=0.5 mm, a=1.07 mm;

FIG. 63 shows an example of the size and number of facets of a multifaceted through-hole, multiple of four, with n=64, D=8 mm, b=0.5 mm, a=0.29 mm;

FIG. 64 shows an example of the size and number of facets of a multifaceted through-hole, multiple of four, with n=12, D=10 mm, b=0.5 mm, a=4.57 mm;

FIG. 65 shows an example of the size and number of facets of a multifaceted through-hole, multiple of four, with n=16, D=10 mm, b=0.5 mm, a=3.36 mm;

FIG. 66 shows an example of the size and number of facets of a multifaceted through-hole, multiple of four, with n=24, D=10 mm, b=0.5 mm, a=2.11 mm;

FIG. 67 shows an example of the size and number of facets of a multifaceted through-hole, multiple of four, with n=32, D=10 mm, b=0.5 mm, a=1.46 mm;

FIG. 68 shows an example of the size and number of facets of a multifaceted through-hole, multiple of four, with n=64, D=10 mm, b=0.5 mm, a=0.48 mm;

FIG. 69 shows an example of a multifaceted through-hole with the number of its facets non-multiple of four, with n=10, in which it is impossible to position a shank with number of facets n1=16;

FIG. 70 shows a general view of two panels in axonometric projection;

FIG. 71 shows a top view of two interconnected panels (one panel is shown partially);

FIG. 72 shows an octagonal holder shank in axonometric projection, with 8 facets, according to the prior art;

FIG. 73 shows an octagonal holder shank in axonometric projection, with 8 facets, prior art;

FIG. 74 shows section E-E and a side view of an octagonal holder shank with facets (prior art);

FIG. 75-76 show a side view and a view in section F-F of a 16-faceted holder shank with facets in axonometric and orthogonal projections;

FIG. 77 shows a “small hook” holder shank in orthogonal projection and in section G-G;

FIG. 78 shows three “big hook” holder shanks in axonometric projection;

FIG. 79 shows three “big hook” holder shanks in orthogonal projection;

FIG. 80 shows a general view of a tool-storage device with mounted holders;

FIG. 81 shows a segment of a positioning panel with tools mounted thereon by means of holders with a wavy tool-holding element;

FIG. 82 shows a segment of a positioning panel with tools mounted thereon by means of magnetic and leaf holders;

FIGS. 83-96 show holders of different shapes in axonometric projection:

FIG. 83 shows an example of a “small hook” holder with a wavy element and one multifaceted shank;

FIG. 84 shows an example of a “middle hook” holder with a wavy element and two cylindrical shanks;

FIG. 85 shows an example of a “big hook” holder with a wavy element;

FIGS. 86-88 show leaf holders for bits and heads:

FIG. 86 shows a leaf holder in axonometric projection for ¼ heads;

FIG. 87 shows a leaf holder in axonometric projection for ½ heads and 5/16 bits;

FIG. 88 shows a leaf holder in axonometric projection for ¼ bits;

FIG. 89 shows a tray holder in orthogonal projection;

FIG. 90 shows a bottom view, a detail of installation example of a “big hook” holder shank at an angle of 90°;

FIG. 91 shows a magnetic holder in axonometric projection;

FIG. 92 shows a holder for a sticker—badge in axonometric projection;

FIG. 93 shows a non-groove holder with a spacing part, in orthogonal projection;

FIG. 94 shows a “big hook” holder, in orthogonal projection, with three cylindrical shanks;

FIG. 95 shows an example of elastic zone of a small double-shank holder;

FIG. 96 shows an example of elastic zone of a small triple-shank holder;

FIGS. 97-100 show installation examples of shanks with a number of facets of 24, 32, 64 in holes with n=16, D=8 mm is a diameter of a circumscribing circle along the vertices of a polygon formed by facets (all vertices are inside the circumference);

FIG. 101 shows an example of a smaller facet with a concave radius R=0.1 mm.

### DETAILED DESCRIPTION OF THE PREFERRED EMBODIMENT

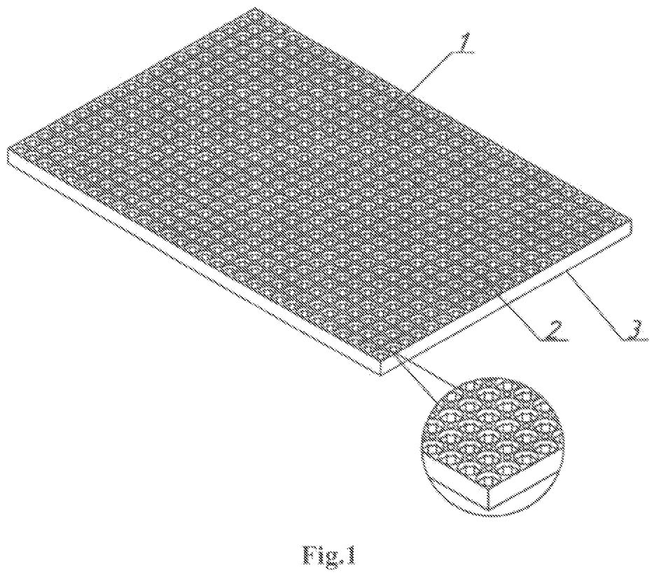

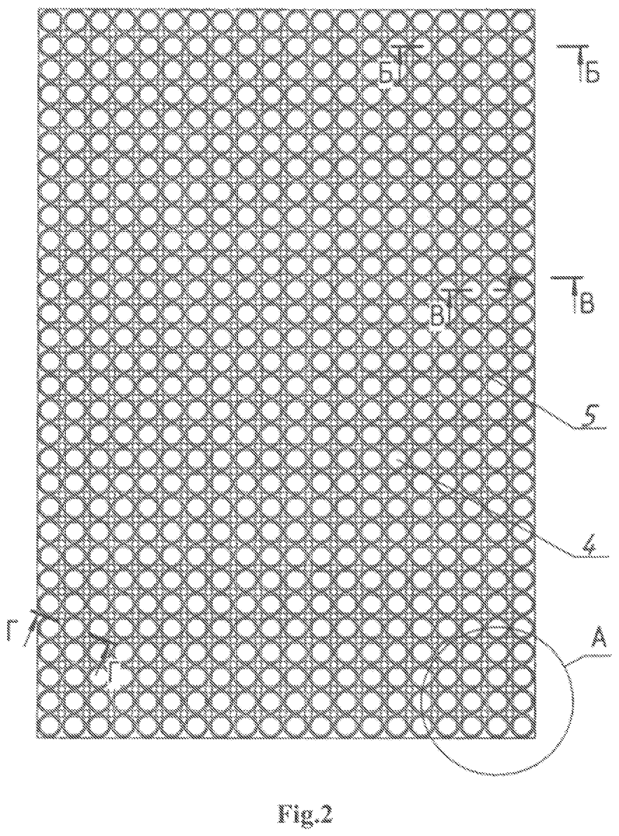

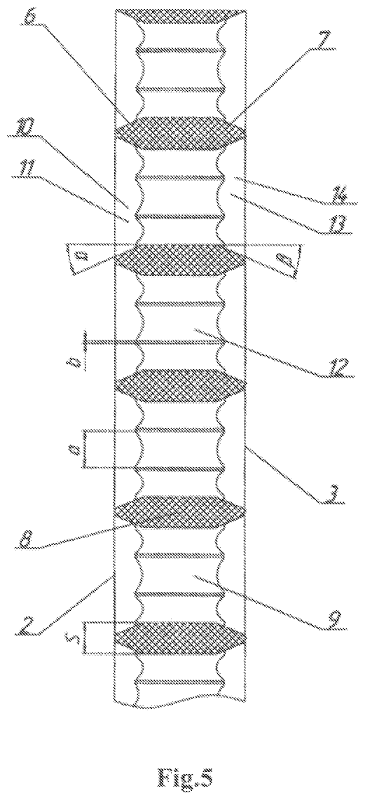

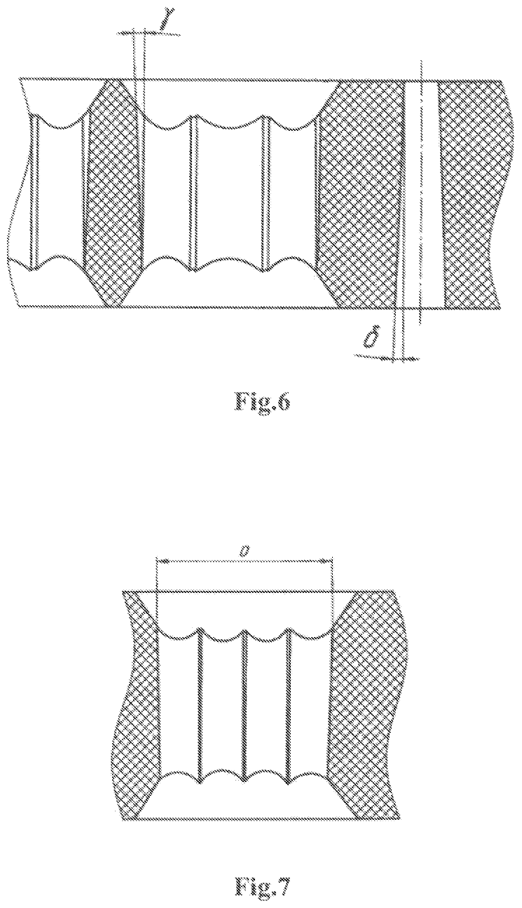

Positioning panel 1 made of plastic has front surface (top part) 2 and base (bottom part) 3 (FIG. 1). Panel 1 has multifaceted through-holes 4 (FIG. 1-4). Multifaceted through-holes 4 alternate with smaller conical through-holes 5 (FIG. 2). A plurality of multifaceted through-holes 4 are arranged in rows (FIG. 2). Smaller conical through-holes 5 narrow (FIG. 6) towards base 3 to fasten the panel from the underside with self-tapping screws, for example, to a stand. It would also be impossible to get the panel out of the die during casting.

The smaller conical through-holes have a diameter of no more than 3.5 mm.

The panel has chamfers at the location of multifaceted through-holes 4: upper chamfer 6 in top part 2 of panel 1 (from the side of front surface 2 of panel 1) and lower chamfer 7 in the bottom part of the panel (from the side of base 3) along the perimeter of multifaceted through-holes 4 (FIGS. 5-6). Chamfers 6 and 7 have slope angles α and β(slope angles α and β are angles between the plane perpendicular to the top and bottom surfaces of the panel, and the chamfer plane) within (20-50)° (FIG. 5-6); slope angles α and β can also be defined as slope angles of the chamfer from the axial line of the multifaceted through-hole. The chamfer is made to a depth of at least 2 mm.

Multifaceted through-holes 4 are made in panel 1 with sloped side facets. Adjacent facets a and b of multifaceted through-holes 4 have slope angle γ (gamma) of each facet (angle between the plane of the multifaceted through-hole facet and the plane perpendicular to top surface 2 and bottom surface 3 of panel 1) within (0.1-4)° (FIG. 6). Slope angle γ can be defined as a facet slope angle from the axial line of multifaceted through-hole 4.

Multifaceted through-holes 4 narrow (FIG. 6) towards base 3. There is wall 8 between multifaceted through-holes 4 (FIG. 5).

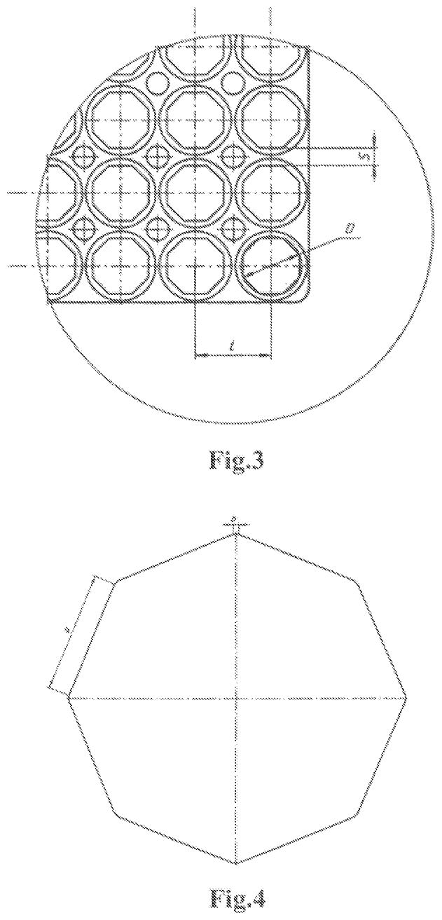

The multifaceted through-holes have pitch L within (8-20) mm, diameter D within (6-10) mm, wall thickness S between the multifaceted through-holes within (2-14) mm (FIG. 3).

Facets 9 of multifaceted through-holes 4 simultaneously meet two conditions: the number of facets 9 is more than eight, but is multiple of four. Adjacent facets a and b of multifaceted through-holes 4 have different width, while the maximum width of facet a is no more than 4.91 mm and of facet b is no more than 0.3 mm (FIG. 5, 7).

Facets b can be concave with a radius of at least 0.3 mm (FIG. 6).

Conventionally, multifaceted through-hole 4 in the panel is conveniently divided into three parts: first top part 10 of multifaceted through-hole 4 is conical cylinder 11 narrowing from front side 2 of panel 1 towards base 3;

second or middle part 12 of multifaceted through-hole 4 is prismatic narrowing at an angle towards base 3;

third bottom part 13 of multifaceted through-hole 4 is conical cylinder 14 widening towards base 3 (FIG. 5, 6).

Positioning panel 1 is made of ABS plastic.

Such embodiment of the positioning panel and multifaceted through-holes 4 allows to use holders 15 of various shapes, which shall have shank 16.

Shank 16 is made as one piece with tool-holding element 17 of holder 15. Shanks of various shapes are used for such multifaceted through-holes of the positioning panel: with groove 18 in the body of shank 16 and without a central groove in the body of shank 16, mainly with collar (shoulder) 19 at the body base of shank 16. The diameter of collar 19 (if the shank is made with groove 18) is selected (from the prior art) more than the diameter of multifaceted through-hole 4. Shank 16 can be made with facets 20 (if the holder has one shank 16) or without them, i.e. cylindrical (if the holder has more than one shank 16). The upper part of shank 15 can have an annular boss whose shape and size correspond to collar 19 and chamfer 6 on the top surface of the panel for tight engagement of shank 16 with panel 1. To remove holder 15 from panel 1, just compress shank 16 at the location of collar 19, disengage it from base 3—the bottom surface of panel 1 and chamfer 7 in multifaceted through-hole 4, and remove it.

Shank 16 is held in multifaceted through-hole 4 by elastic deformation force and by engagement of collar 19 with bottom surface 3 of panel 1 or with chamfer 7.

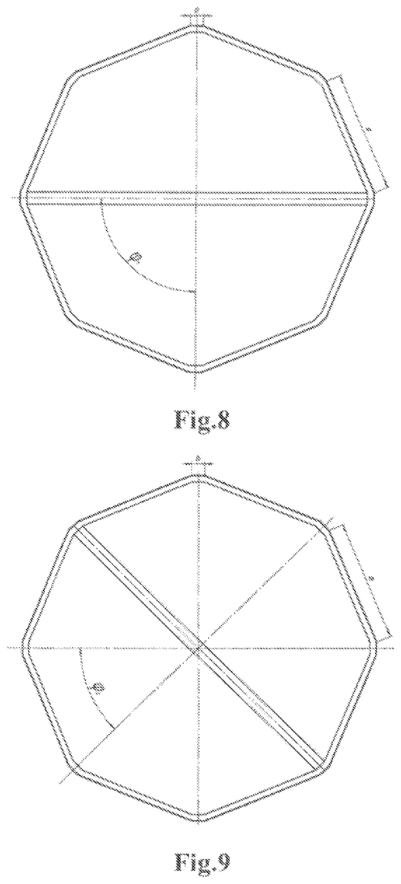

Holders 15 with one shank 16 can be installed on panel 1 in 64 positions (at 22.5°—16 positions, at 11.25°—32 positions, at 5.625°—64 positions), unlike the prior art. In the prior art, holders 15 with one shank 16 can be installed on panel 1 only in eight positions (FIGS. 8-12).

The outer surface of holder 15 can be rough or have a different pattern. When holders 15 are installed in multifaceted through-hole 4 of panel 1, shank 16 is compressed by side walls of multifaceted through-hole 4 due to central groove 18 (or if the shank has no groove, then due to elasticity of the body material of shank 16), it easily fits into multifaceted through-hole 4; shank 16 slides along the inner surface of multifaceted through-hole 4, first through first top part 10 of multifaceted through-hole 4—conical cylinder 11 narrowing from front side 2 of panel 1 towards base 3—chamfer 6, then through second or middle part 12 of multifaceted through-hole 4, which is prismatic narrowing towards base 3, then through third bottom part 13 of multifaceted through-hole 4—conical cylinder 14 widening towards base 3. Middle part 12 of multifaceted through-hole 4 is the longest one compared to top part 2 and bottom part 3 of multifaceted through-hole 4. In general, multifaceted through-hole 4 narrows towards base 3.

If shank 16 has collar 19, like most of shanks 16, then shank 16 with collar 19 slides along the inner surface of multifaceted through-hole 4 until collar 19 reaches base 3 of the bottom surface of panel 1 and is released from multifaceted through-hole 4, in this case shank 16 expands and collar 19 engages with the base—the bottom surface of panel 1, more precisely, with lower chamfer 7.

Different holders can be used in the proposed panel depending on the load. For example, holders with a tool-holding element in the form of wavy lever 21 to fasten different elements:

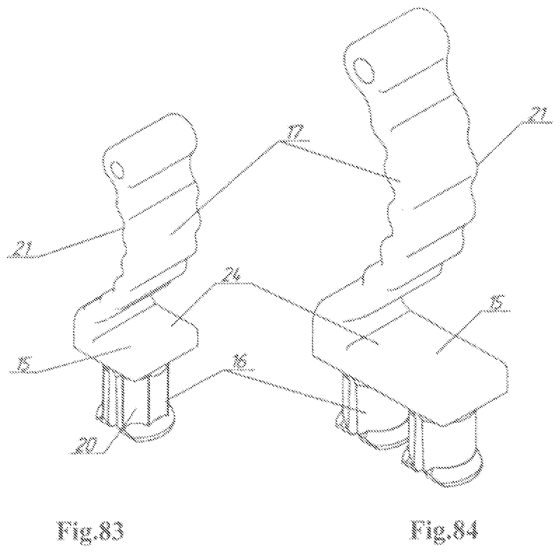

“Small hook” holder 15 (FIG. 83) is a smart and unique lock which allows to fasten most types of tools and other items. The wavy profile of the lock helps better hold the tool without its spinning. The maximum gripping diameter is 35 mm. The recommended load on the lock is 400 grams.

“Middle hook” holder (FIG. 84) is an intermediate variant of a universal lock, designed to fasten medium-size tools: screwdrivers, drills, mallets, etc. The maximum gripping diameter is 65 mm. The recommended load on the lock is 700 grams.

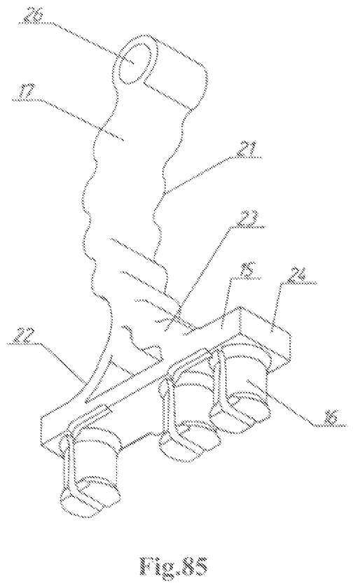

“Big hook” holder 15 (FIG. 85) is the largest universal holder. It is designed to hold large tools. The maximum gripping diameter is 95 mm. The recommended load on the lock is 900 grams. The “big hook” holder is equipped with additional stop 22 which meets the condition: the thickness of this stop 22 shall be at least 2 times smaller than the body thickness of holder 23. The “big hook” holder differs from the “small hook” and “middle hook” holders in that it additionally has stop 24 and third shank 16, and the stop base is enlarged. With three shanks, the load applied by the tool to the holder itself is evenly distributed over all three shanks-stems. Stop 22 allows holding heavier items and tools.

If the holder body is 4 mm thick, this stop is 2 mm thick.

It has been experimentally ascertained that if this stop is more than 2 mm thick, for example, 3 mm thick, then the stop will be more rigid, i.e. it will be harder to insert a tool with a larger diameter as the shank may break away.

The tool-holding element in the form of wavy lever 21 has wave radius R (as opposed to the wave radius of the middle holder). The curvature radius of the “big hook” holder body is greater than the curvature radius of “small hook” and “middle hook” holder bodies, and the height of the tool-holding element in the form of wavy lever 21 for the “big hook” holder is greater, therefore, stop 22 is necessary, since load on the “big hook” holder is higher than on “small hook” and “middle hook” holders. Such a holder can withstand heavy loads.

Holders 15 with a tool-holding element in the form of wavy lever 21 are normally used in pairs. Wavy lever 21 prevents the tool and accessories from spinning in the pair of holders 15 and from falling out. Items or tools are held securely, also in the event of any jolts and impacts when moving panel 1, for example, in a tool box.

Hole 26 (FIG. 85) in “small hook”, “middle hook” and “big hook” holders is made for additional fixation of two holders (when a pair of holders holds a tool or an item). An elastic band is inserted into the holes of both holders to fasten together wavy levers 21, or a wire in the form of a coupler. Even if panel 1 is turned over, item or tool with additional fixation would not fall out of them.

The length of shank 16 is no less than the depth of multifaceted through-hole 4 to ensure the engagement of shank 16 with panel 1.

Shank 16 is made as a one-piece volumetric elastoplastic element that returns to its original shape after it is compressed by side walls of multifaceted through-hole 4.

The “big hook” holder to hold tools in the positioning panel has a tool-holding element and three shanks 16 for installation in multifaceted through-hole 4 of positioning panel 1; and the body of each shank 16 has at least one groove 18 to hold tools; and at the body base of one or each shank 16 there is collar 19 with a ribbed surface.

Three shanks 16 of the “big hook” holder are cylindrical to cut the matrix cost (the matrix breaks down after 2 years).

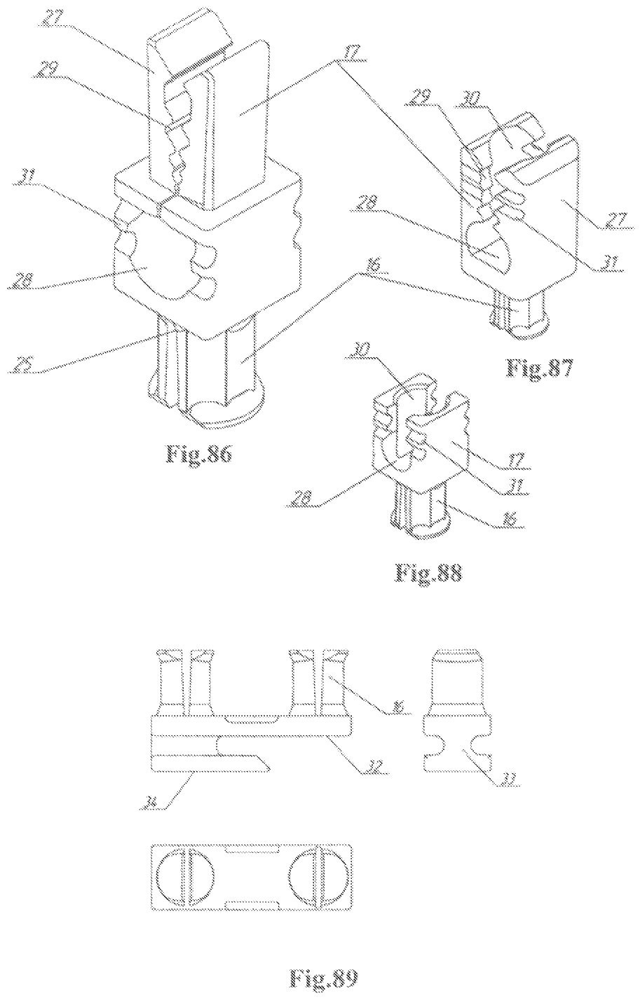

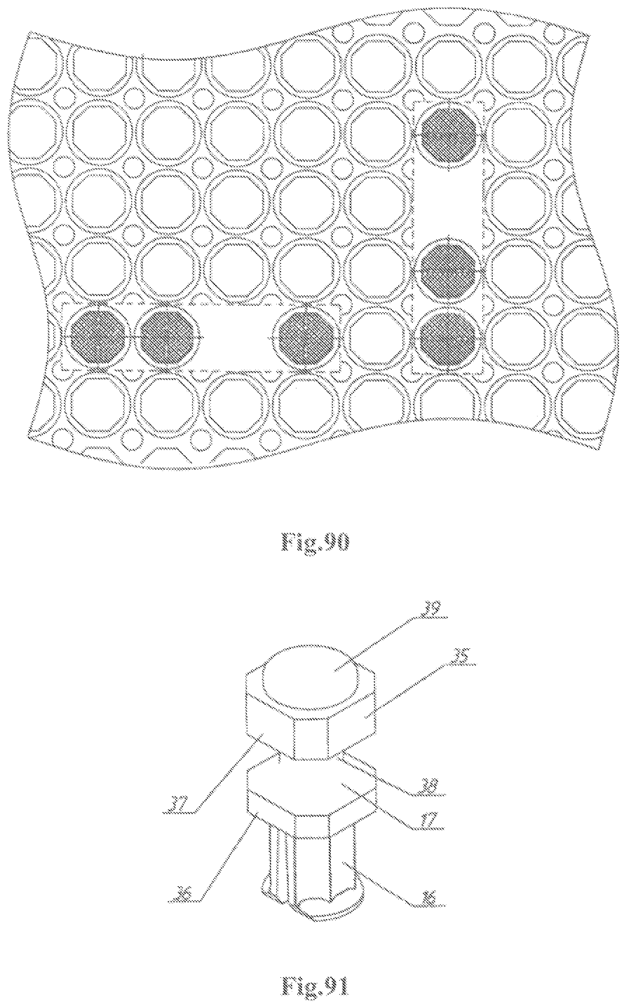

“Leaf′ HOLDER 15 for ¼ heads with tool-holding element 17—leaf element 27 (FIG. 86)— is a unique lock specially designed to fasten any ¼” square sockets. It also allows to fasten miniature tools:drills from 0.5-4 mm; jigsaw blades; hexagons up to 3 mm; open-end wrenches up to 5 mm, tweezers.

“Leaf” holder 15 has faceted shank 16, mainly with 16 or 32 facets.

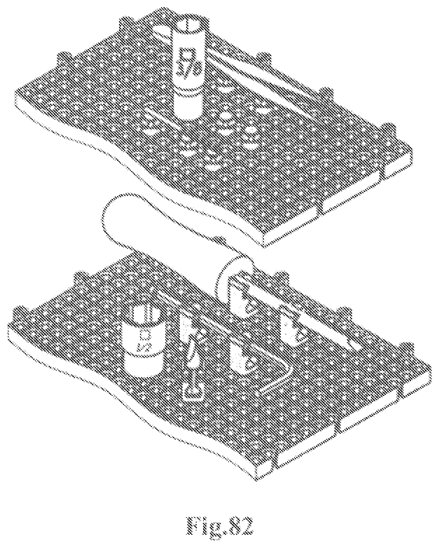

Holder 15 with tool-holding element 17—leaf element 27—helps hold small-diameter or small-size tools on panel 1, as well as tools without handles or small tool accessories (for example, hexagonal angle screwdrivers, long thin drills), tool bits and interchangeable heads. The shape of leaf element 27 is generally close to a rectangular parallelepiped (FIG. 86-88). Tools, including those with a small diameter or small size, as well as tools without handles or small tool accessories are installed in groove 28 in the holder body and are held by elastic deformation forces produced by groove 28, in this case teeth in groove 29 prevent the tool from displacement (FIG. 82). Groove 28 and teeth 29 in groove 28 can be of different sizes to suit different tools, for example, leaf element 27 shown in FIG. 86-88, thanks to narrow groove 24 and small teeth in groove 24, can hold drills or screwdrivers up to 1 mm in diameter. Groove 28 can have different shapes to suit different tools, for example, groove 28 can have a broadening in the form of cylindrical (or almost cylindrical) hole 8, which allows to hold large-diameter tools (FIG. 82). A person skilled in this technical field understands that groove 28 in the body of holder 15 with leaf tool-holding element 27 can be vertical, horizontal, or inclined, and several grooves can be made in the body of holder 15. Holders 15 with leaf tool-holding elements 17 also hold fine tips of tools, such as screwdrivers, while holders 15 with wavy tool-holding element 21 hold handles of such tools (FIG. 82). Tool bits and interchangeable heads are installed into vertical cylindrical recess 30 in leaf tool-holding element 27, and interchangeable heads can also be installed over leaf tool-holding element 27. Thus, the number of types of tools that can be placed and stored on the proposed to device increases significantly. Horizontal furrows 31 on the outer surface of the holder with leaf tool-holding element 17 allow holder 15 to be conveniently held with fingers, removed from multifaceted through-holes 4 of panel 1 or inserted into them (FIG. 86-88). Instead of furrows, the outer surface of the holder can be rough or have a different pattern.

A “½ socket holder” (FIG. 87) is a multifunctional holder of ½″ square sockets or 5/16″ bits. Also the following can be fastened:open-end wrenches of 7-12 mm; drills of 3-6 mm; hexagons of 3-10 mm; tweezers and clamps. It acts as a stop in combination with other holders. The “½ socket holder” has faceted shank 16, mainly with 16 or 32 facets.

A “¼ bit holder” (FIG. 88) is used specifically to fix socket bits (of ¼″ size). It can be used as a stop in combination with other locks.

Tool bits and interchangeable heads are installed into vertical cylindrical recess 30 in leaf tool-holding element 27. The “¼ bit holder” has one faceted shank 16, mainly with 16 or 32 facets.

“Tray holder” 15 (FIG. 89) is used to fasten plastic boxes of various series, which can be mounted on a DIN rail. The required number of holders is installed depending on the size and load. It also acts as a hanger. The tray holder consists of two rectangular plates (in front there is a longer bottom plate 32) connected by stem 33 or a column with bottom plate 34. Top plate 34 is shorter, when viewed from the front, it has a 45° slope towards stem 33 or support, radius chamfers are removed from all edges, i.e. rounded—the chamfers are caused by an injection mold.

Stem 33 is rounded inward from the slope side of top plate 32—platform and from the holder sides, i.e. inside the stem body with a radius of 3.1 mm (the back of stem 33 is vertical and slightly recessed in relation to the top and bottom plates (above—this line is caused by a molding joint of 2 parts of the mold)). Two tray holders are connected by their rear sides to form a DIN rail. The tray holder has two cylindrical shanks.

“Magnetic” holder 35 (FIG. 91) (with a magnet) has at least 8 facets. It is designed to install sockets, including elongated ones. A ¾ socket can be mounted either on a magnetic holder or on top of one or two magnetic holders.

The top part of the magnetic holder is made in the form of lower and upper polygons 36 and 37, connected by stem 38. Magnet 39 is inserted from above into the polygon in the form of a round tablet. Magnets with a certain strength are used to hold tools and items. Magnets are selected for a certain type and weight of an item, part or tool that has magnetization. The magnet bonding force is no less than 1 kg (10 N). “Magnet” holder 35 has one faceted shank 16, mainly with 16 or 32 facets.

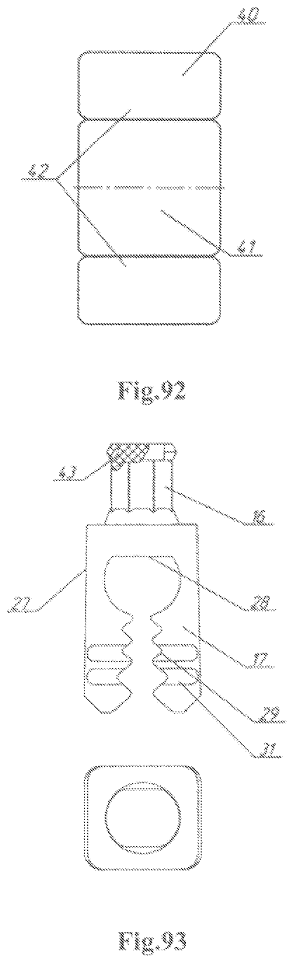

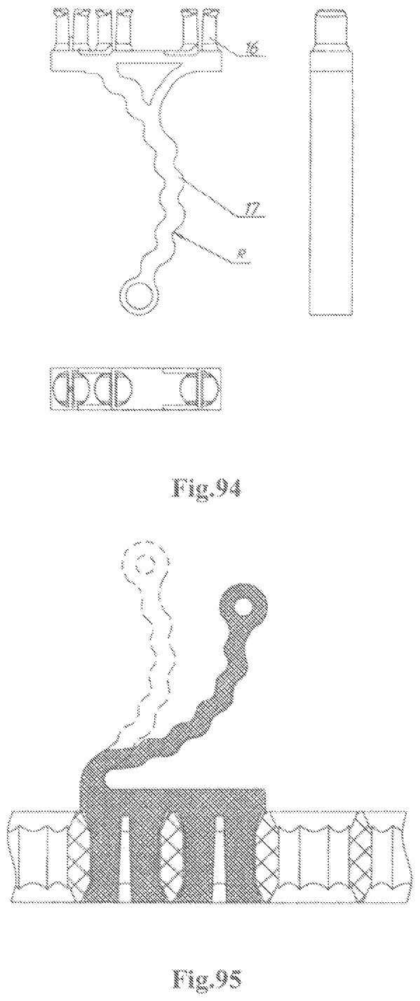

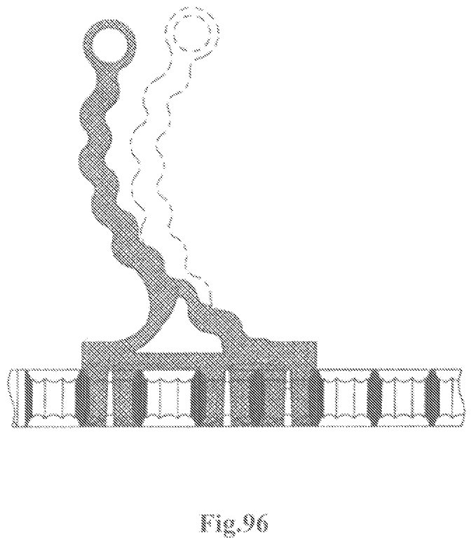

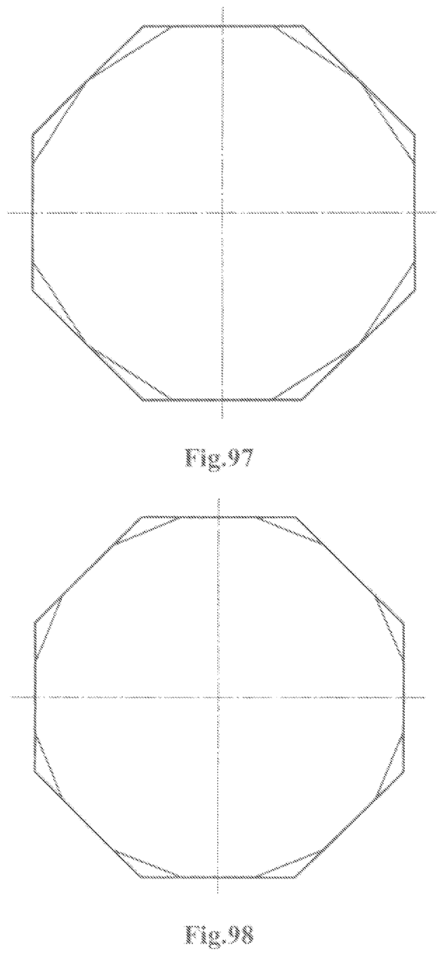

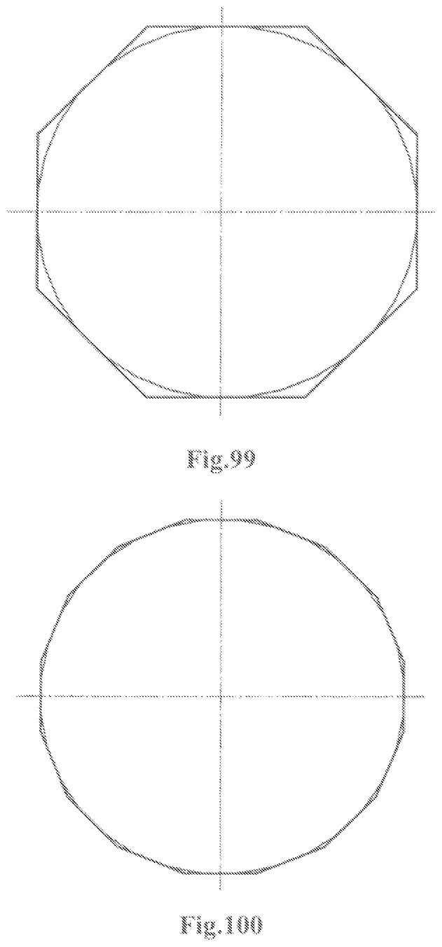

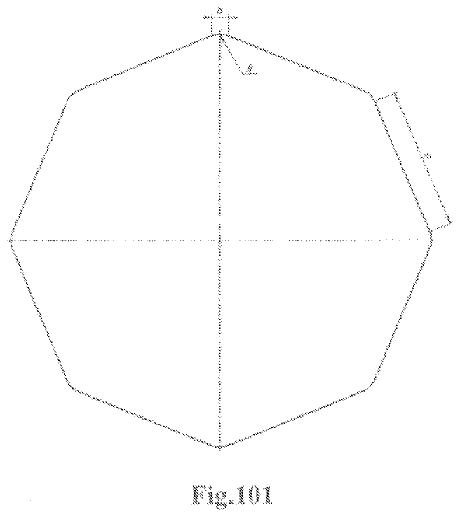

“Badge” holder 40 (FIG. 92). The BADGE holder is designed for convenience. BADGE holder 40 is used in the panel so that there is no need to memorize which tool and where is located on the panel. When the panel is assembled with a set of holders for tools and various items, and the user has decided on the arrangement of tools, then it can be safely attached to panel 1 in the places where tools are located. The badge has central part 41 (the largest part) and two extreme parts (lateral parts smaller than the central part) 42.

Faceted shank 16 (the number of facets of one shank is multiple of four, but is no more than eight, and adjacent facets have different width, mainly 16 or 32 facets) can be made without a groove (FIG. 93), but with flats removed, with spacing part 43 (which is made, for example, in the form of whiskers), which first expands during installation when entering multifaceted through-hole 4. When passing multifaceted through-hole 4, faceted shank 16 with spacers—with spacing part 43 is also deformed due to elastic properties of material. After passing through the hole, shank 16 returns to its original shape. The shank can have protrusions, for example, of a spike-type.

There can be a protruding multifaceted element on the side of panel 1. The number of facets of the multifaceted element is multiple of four, but is no more than eight. For example, it is possible to make protruding elements with number of facets n, mainly 16 or 32, on two adjacent sides of the panel. The protruding multifaceted elements can have a collar (shoulder) at the bottom.

Using the protruding elements, it is also possible to connect the panels to each other, enlarging the area for tool arrangement; in this case, one shank 16 mainly with 16 or 32 facets is inserted into one panel, the second shank mainly with 16 or 32 facets is inserted into the adjacent panel. The panels can be connected to each other with fasteners in the form of several multifaceted elements protruding from the panel side and having a groove along their axis, and with corresponding extreme through-holes on the opposite side of the panel, which have a vertical slit along the panel side. The shape and size of the protruding multifaceted elements correspond to the multifaceted through-holes in the panel. The protruding multifaceted elements mainly with 16 or 32 facets on one panel are inserted into corresponding extreme through-holes on the other panel using the vertical slit on the panel side and are held in them by elastic deformation force produced by the groove along the axis of the protruding multifaceted element. By such fastening, the panels are easily and firmly connected to each other and can also be easily disconnected. The protruding multifaceted elements are located below front surface 2 of panel 1 by at least 2 mm. This is necessary so that the head of a screw or fastener does not protrude above front surface 2 of panel 1. In this case, the structure assembled from several panels 1 looks like a large single panel. No fasteners are visible in such a structure.

The protruding multifaceted elements mainly with 16 or 32 facets on two adjacent sides of the panel permit the panels to be attached to each other on both sides, thereby improving the panel functionality and convenience. Users can create panels of the size and shape they require.

It also improves the panel usability.

The panel operates as follows.

Shanks 16 of holders 15 are positioned in two mutually perpendicular axes.

The greater the number of facets n1 of shank 16 as compared to the number of facets n of multifaceted through-hole 4, the more options there are to position the holder if n1>n.

FIGS. 8-12 show various examples of installing shanks 16 with different facets n1 and different shapes into multifaceted through-holes 4 with facets n and with rotation at different angles φ(examples of positioning the holder shanks at different angles): 5.625°, 11.25°, 22.5°, 45°, 90°, bottom view:

FIGS. 8 and 9 show examples of 90° and 45° rotation of shanks in the multifaceted through-hole: with the number of facets n=16 of multifaceted through-hole 4, provided that a>b with b=0.1 mm, with D=8 mm (i.e. within 6-10 mm) (the diameter of a circumscribing circle along the vertices of a polygon formed by facets (all vertices are inside the circumference), the holder with a shank and the number of facets n1=16.

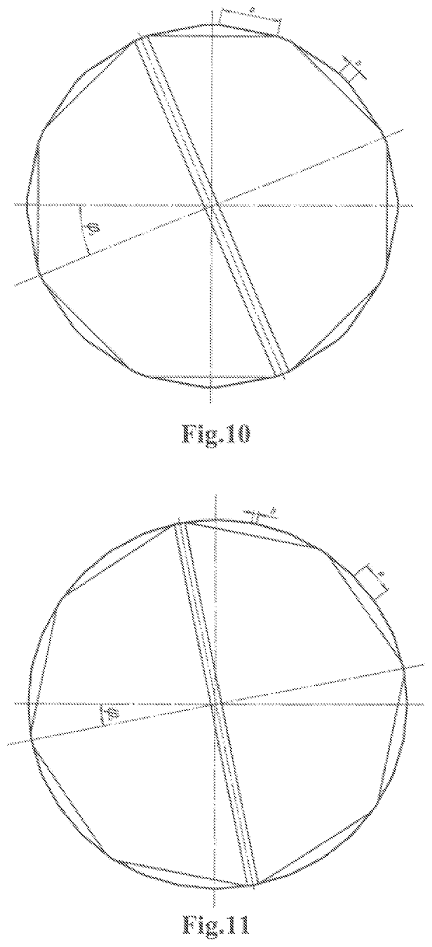

FIG. 10 shows examples of 22.5° rotation of shanks in the multifaceted through-hole: with the number of facets n=32 of multifaceted through-hole 4, provided that a>b with b=0.1 mm, with D=8 mm, the holder with a shank and the number of facets n1=16.

FIG. 11 shows examples of 11.25° rotation of shanks in the multifaceted through-hole: with the number of facets n=64 of multifaceted through-hole 4, provided that a>b with b=0.1 mm, with D=8 mm, the holder with a shank and the number of facets n1=16.

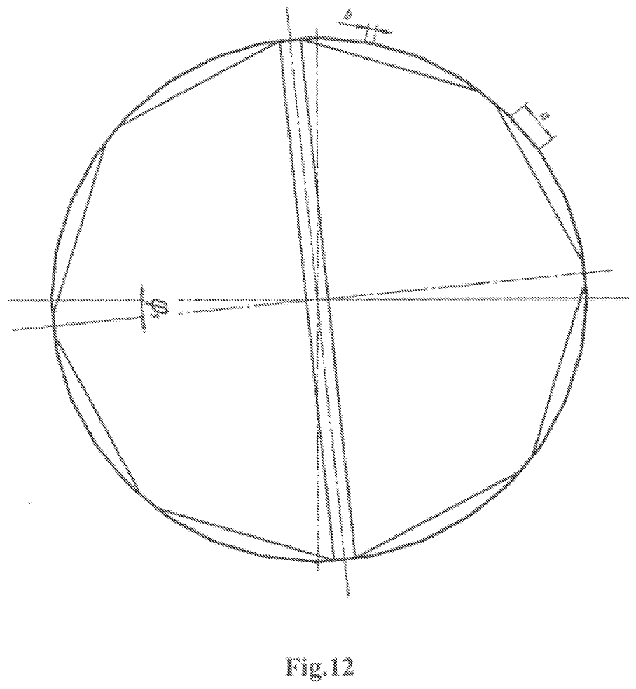

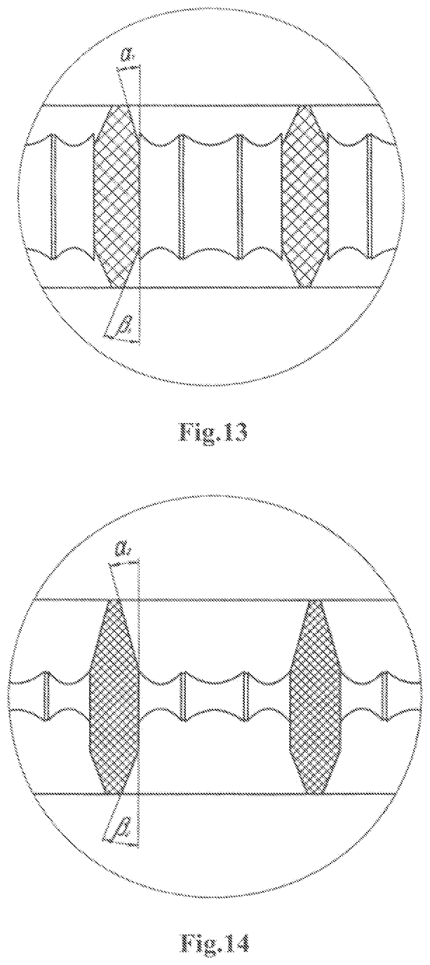

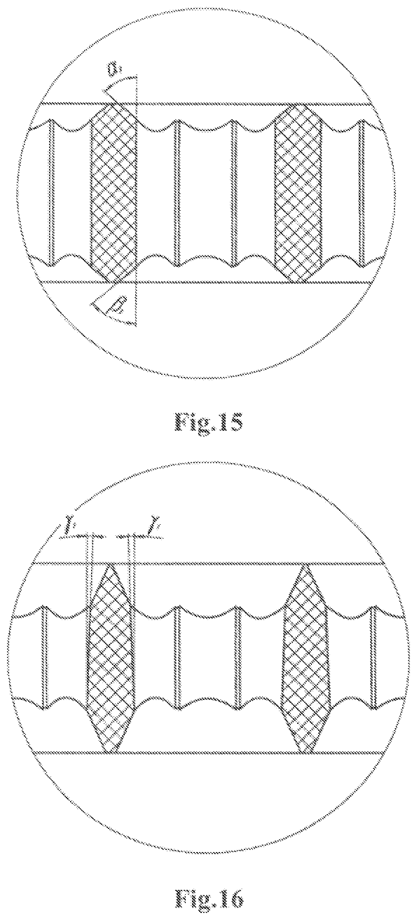

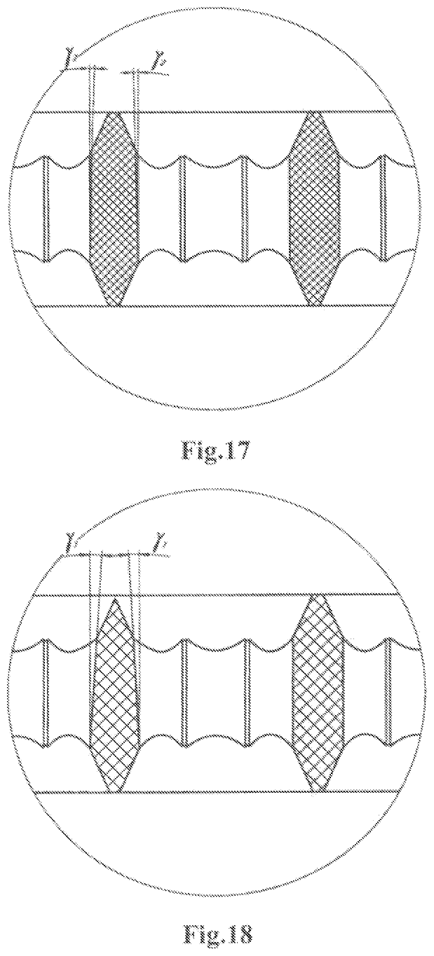

FIG. 12 shows examples of 5.625° rotation of shanks in the multifaceted through-hole: with the number of facets n=128 of multifaceted through-hole 4, provided that a>b with b=0.1 mm, with D=8 mm, the holder with a shank and the number of facets n1=16.

The facets of multifaceted through-hole 4 are required to ensure a correct fit of holder shank 16 in multifaceted through-holes 4. The holder will not fall out of the multifaceted through-hole, since the fixation takes place along lower chamfer 7 in bottom part 3 of panel 1.

If the number of facets n of multifaceted through-hole 4 differs from (i.e. is inconsistent with) the number of facets n1 on the shank body, the “contact pattern” changes.

The “contact pattern” is an optimal, guaranteed area of contact between facets n of multifaceted through-hole 4 and facets n1 on the body of shank 16.

FIGS. 10, 11 and 12 show examples for n>n1:32>16 64>16 and 128>16.

If the number of facets on the body of shank 16 installed in panel 1 is greater than the number of facets of the multifaceted through-hole with facets n1>n or on the contrary, is less n1≤n, then the forces of shank engagement with the panel are sufficient. The contact area (“contact pattern”) of the facets of shank 16 with the facets of multifaceted through-hole 4 decreases. But the engaging force of shank 16 in multifaceted through-hole 4 is sufficient to prevent spontaneous spinning of the shank because the load is distributed symmetrically along all facets of multifaceted through-hole 4.

The experiment shows that the engaging joint of shank 16 in multifaceted through-hole 4 with the panel is operational.

Shanks 16 of holders 15 are positioned in two mutually perpendicular axes.

For example, if faceted through-hole 4 is made with 10 facets (FIG. 69), i.e. the number of facets is more than eight, but is not multiple of four. In this case, faceted through-hole 4 will have only one symmetry axis. Such a hole is not suitable to position the shank, since the shank fails to take up the required position in multifaceted through-hole 4 of panel 1 as shown in FIG. 69. In this case, there is no “contact pattern”, which is an optimal, guaranteed area of contact between facets n of multifaceted through-hole 4 and facets n1 on the body of shank 16. Unlike the prior art, multifaceted through-holes 4 in panel 1 in the proposed panel have different facets, however opposite facets (for example, a) of multifaceted through-hole 4 shall be of the same size, i.e. the same width, pairwise symmetric, pairwise equal to each other.

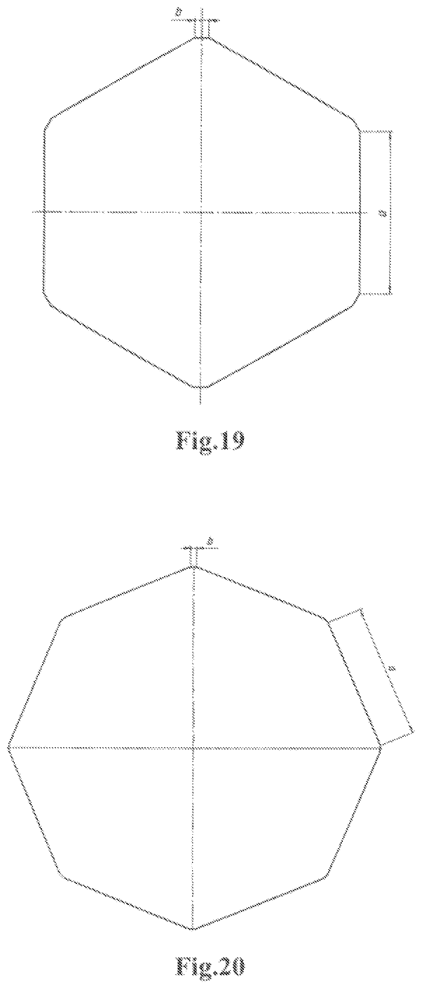

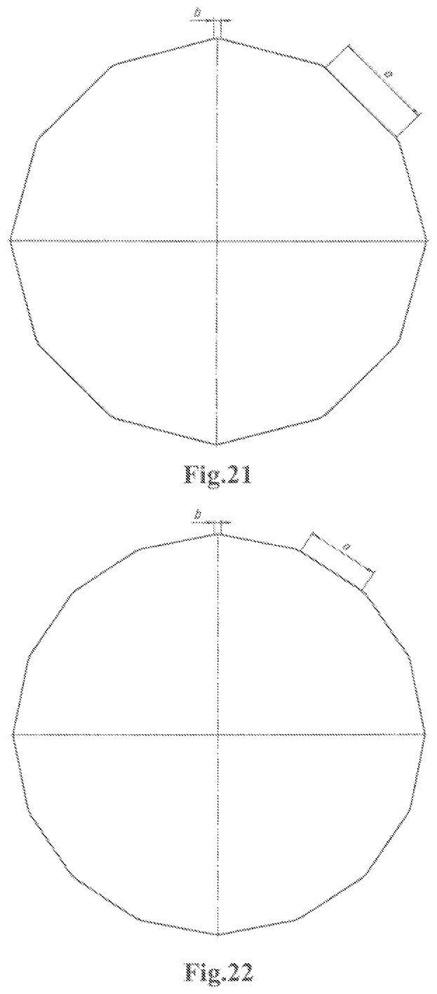

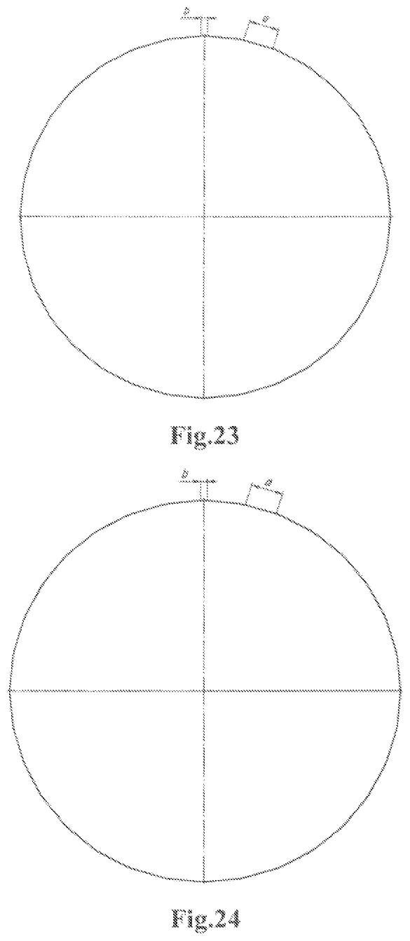

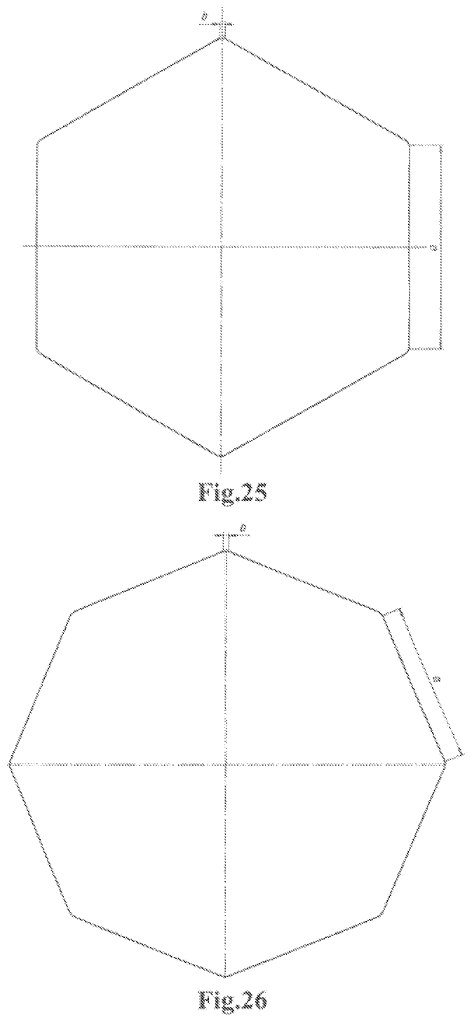

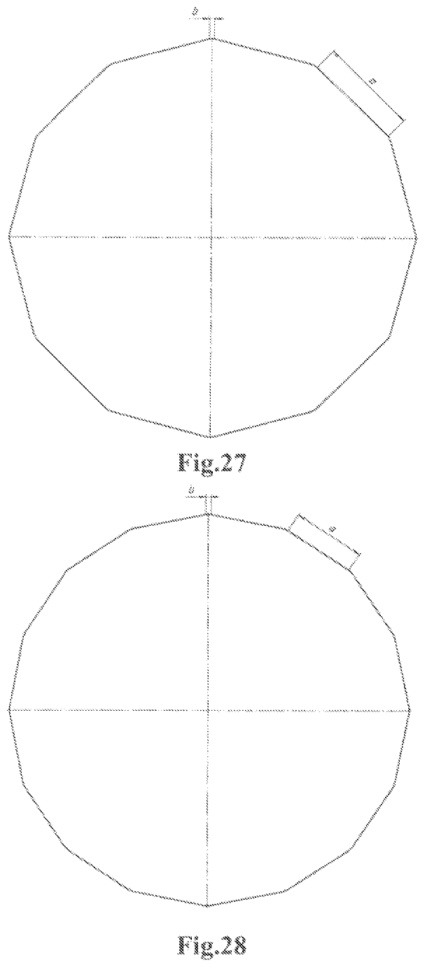

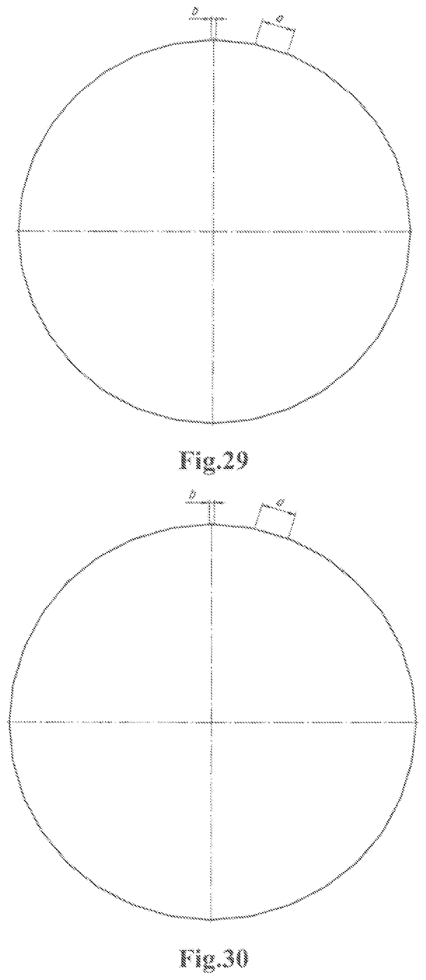

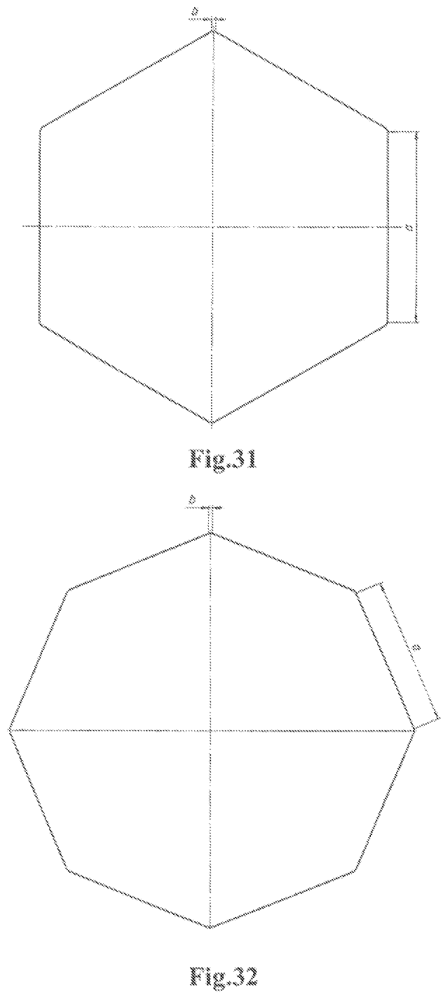

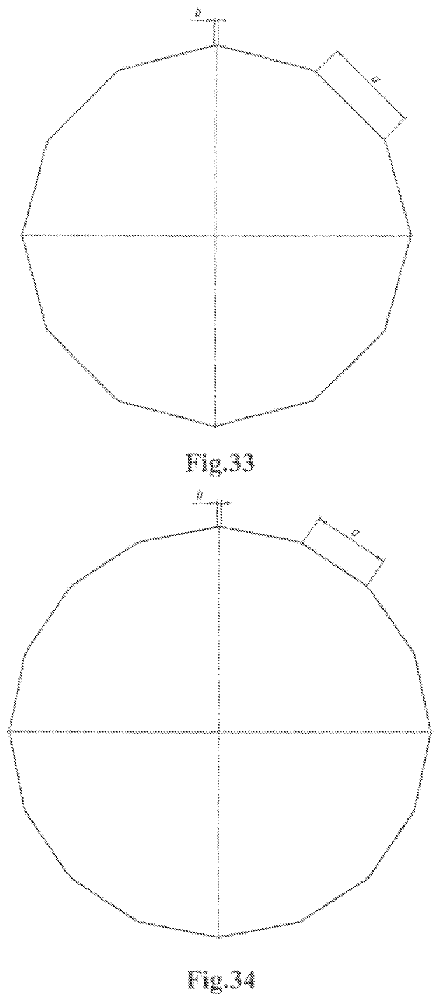

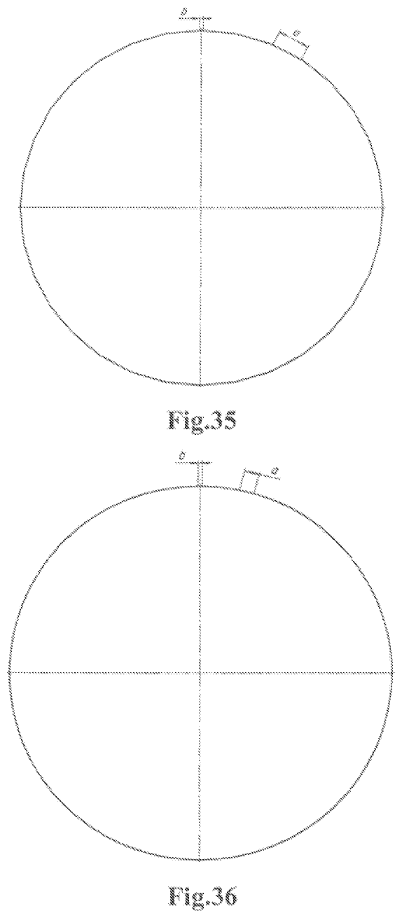

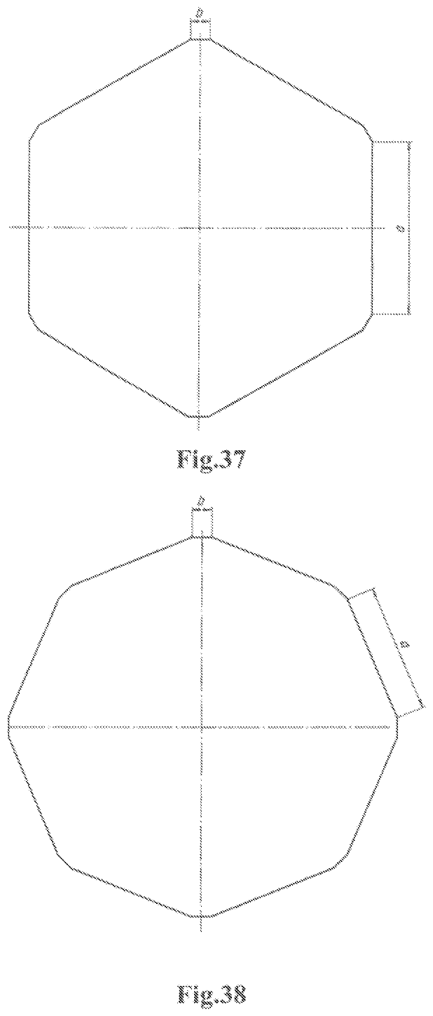

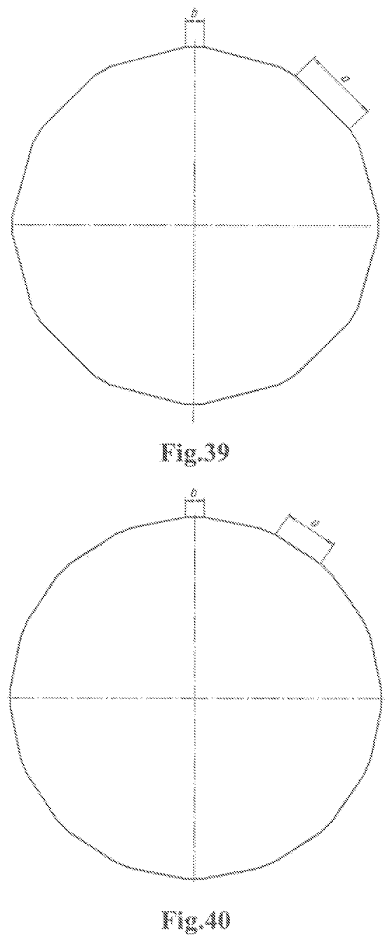

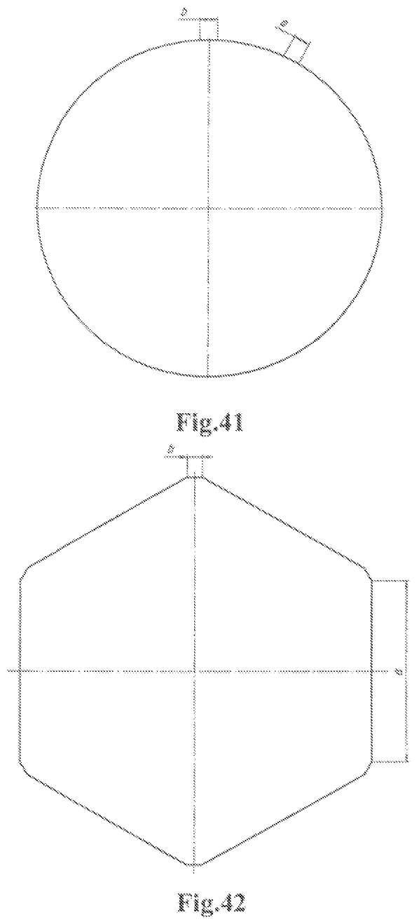

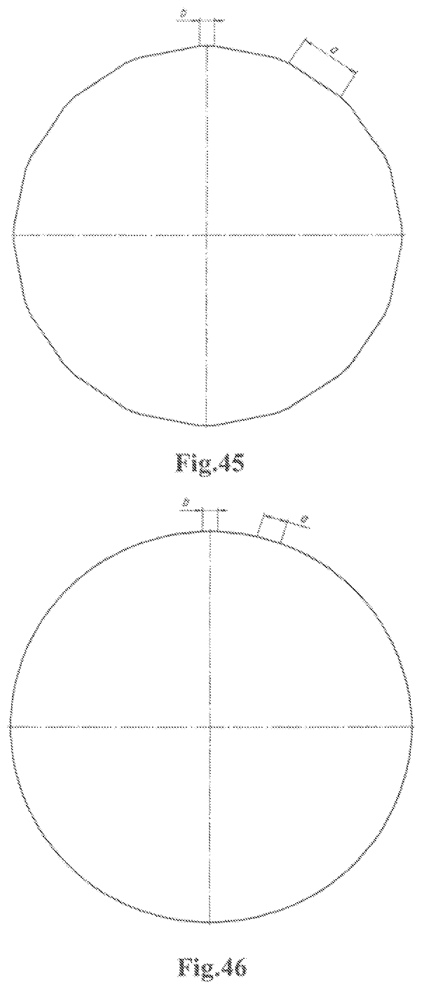

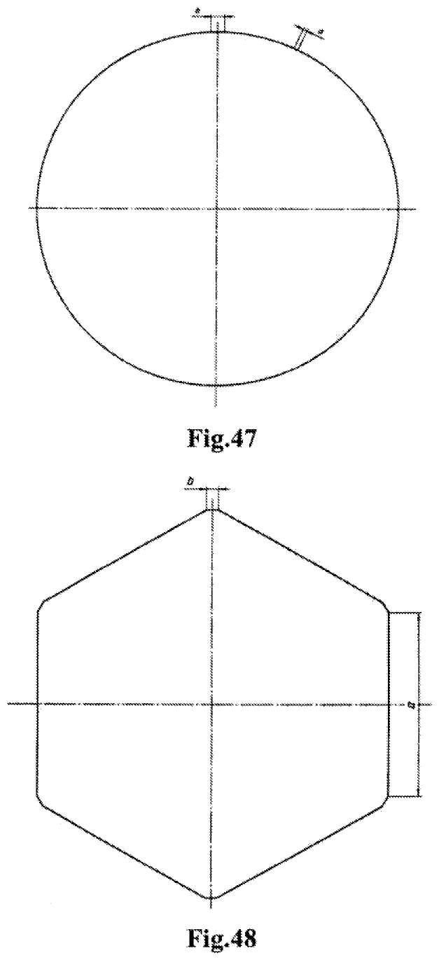

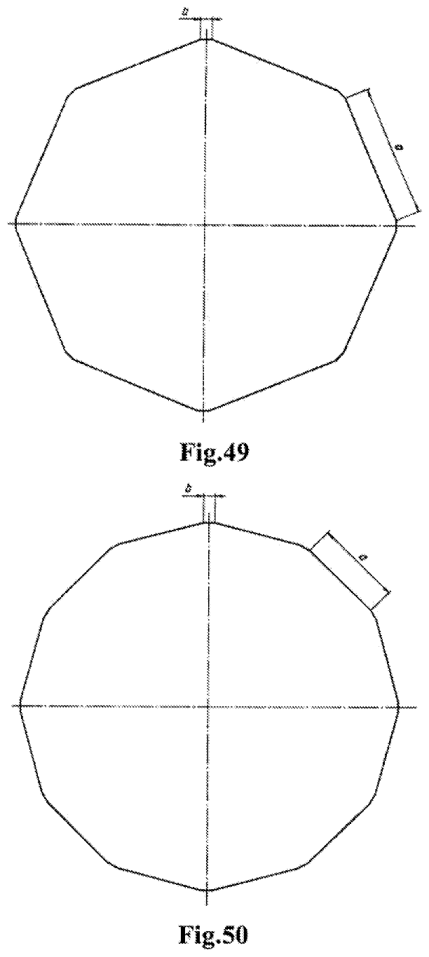

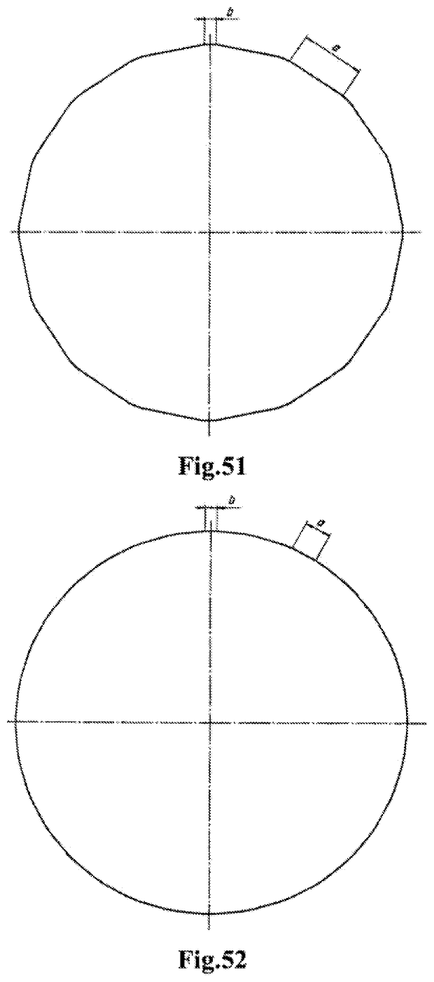

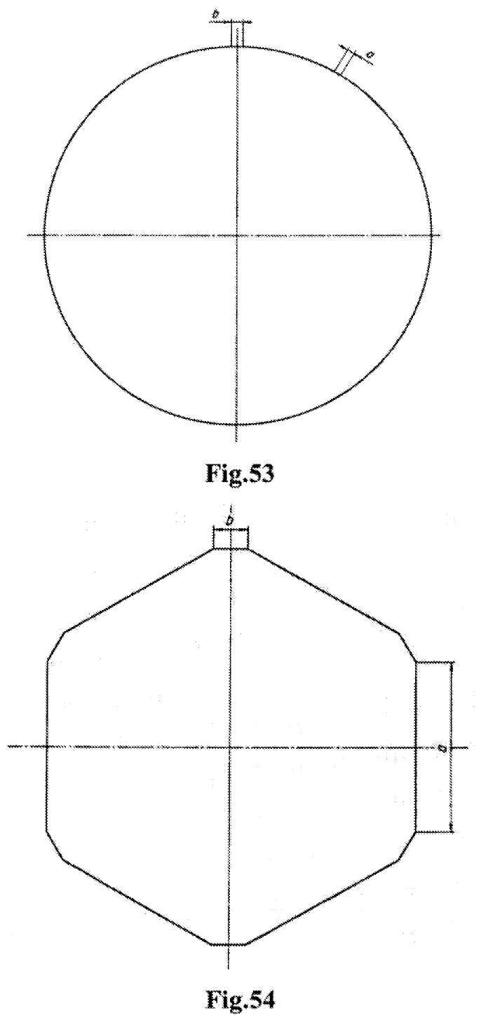

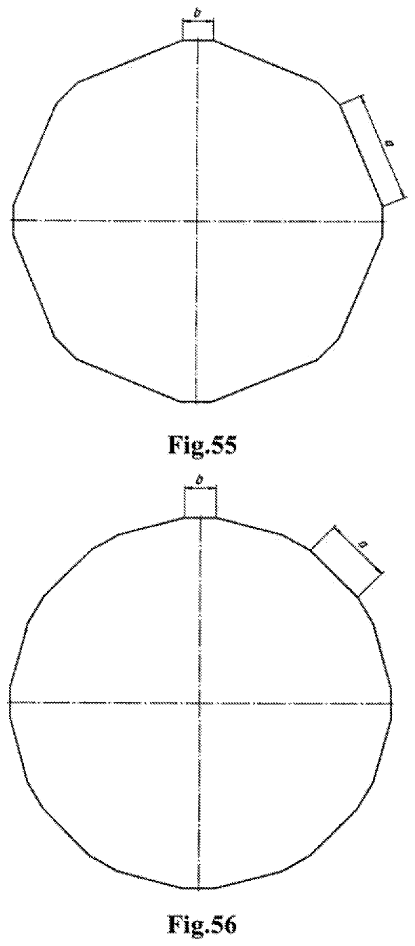

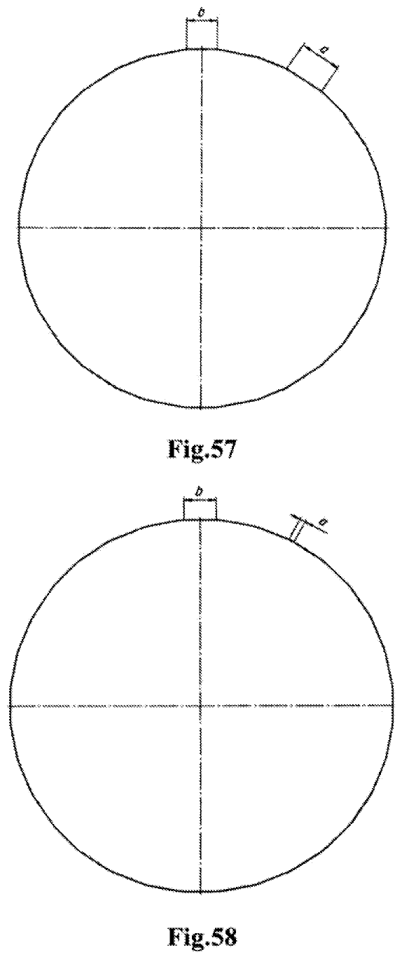

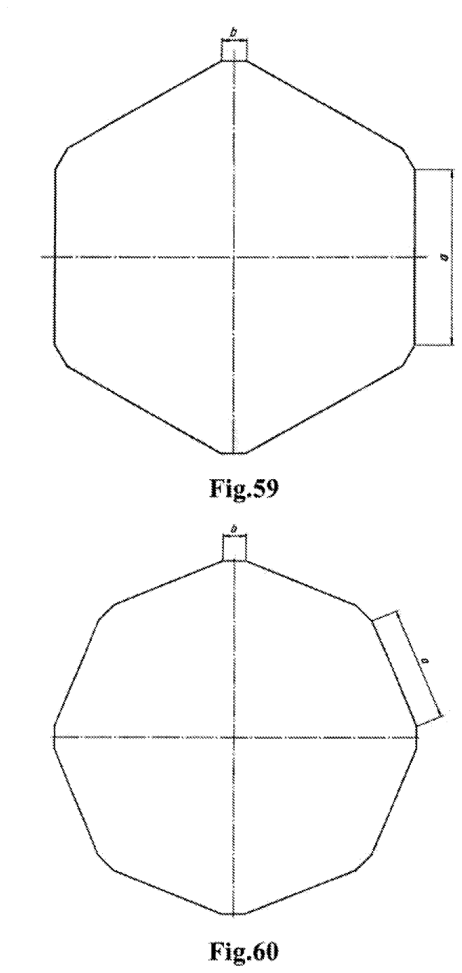

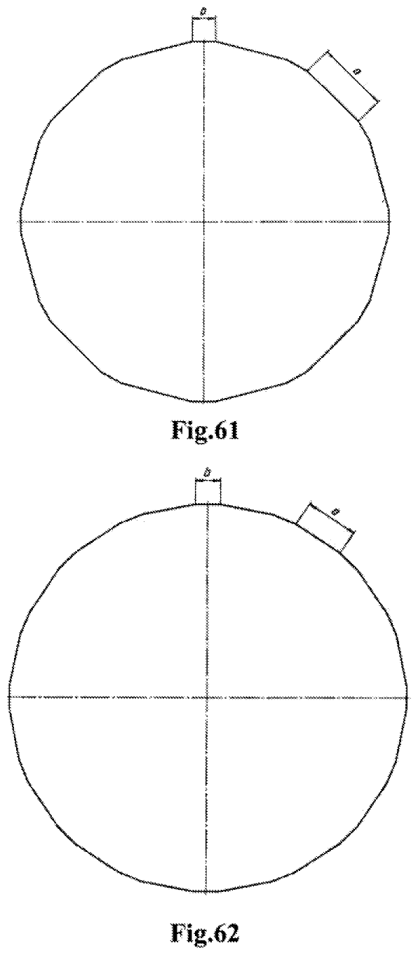

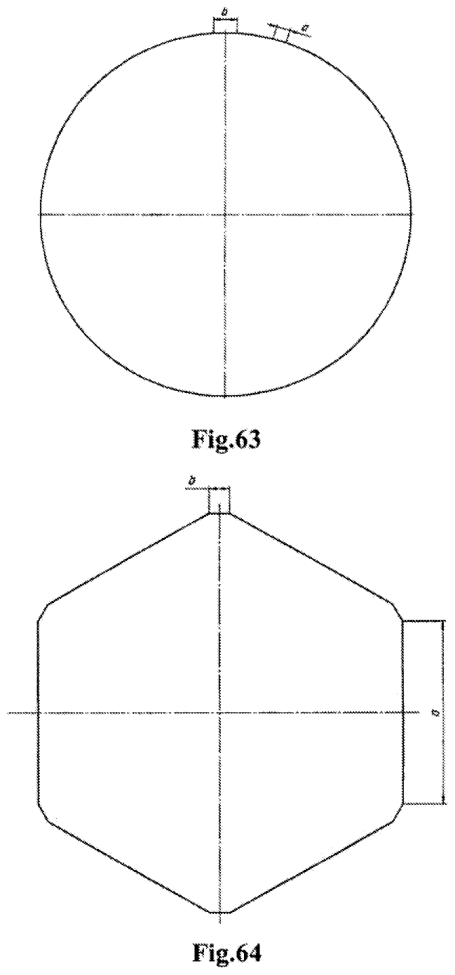

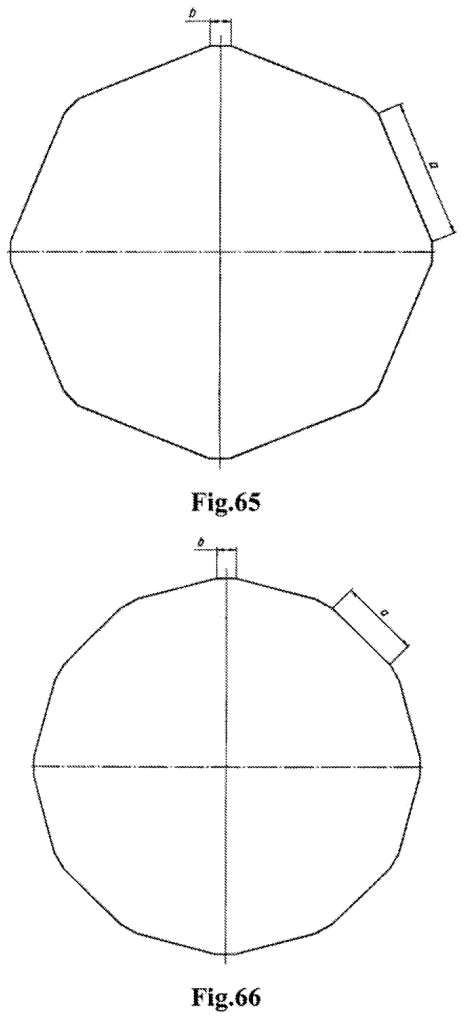

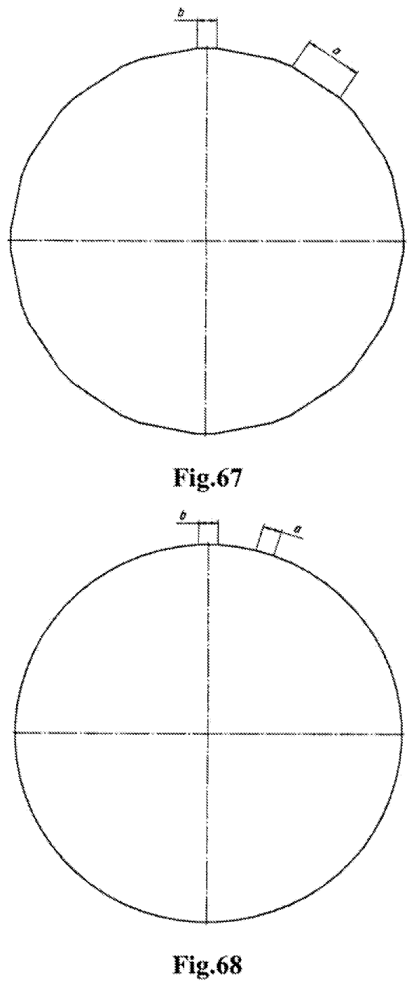

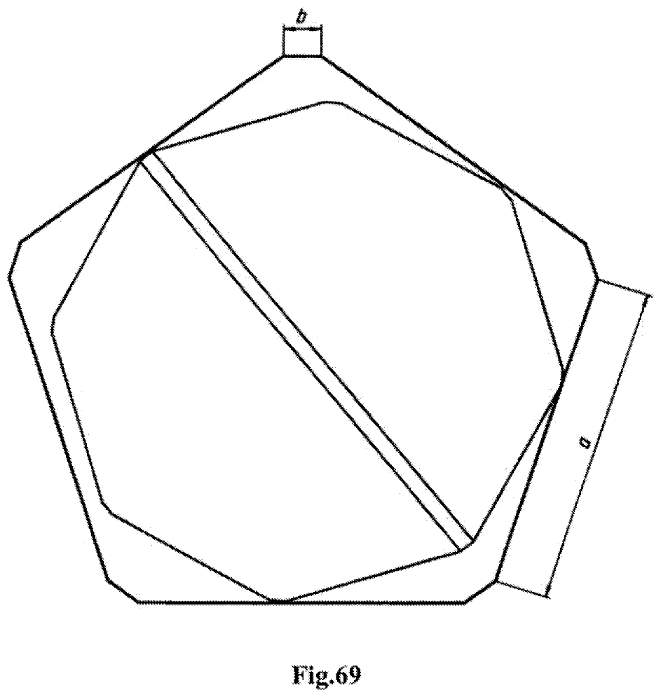

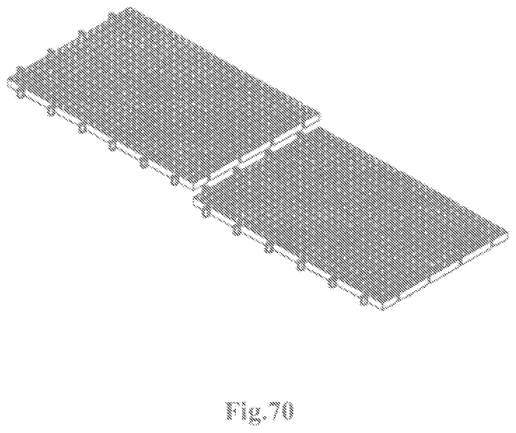

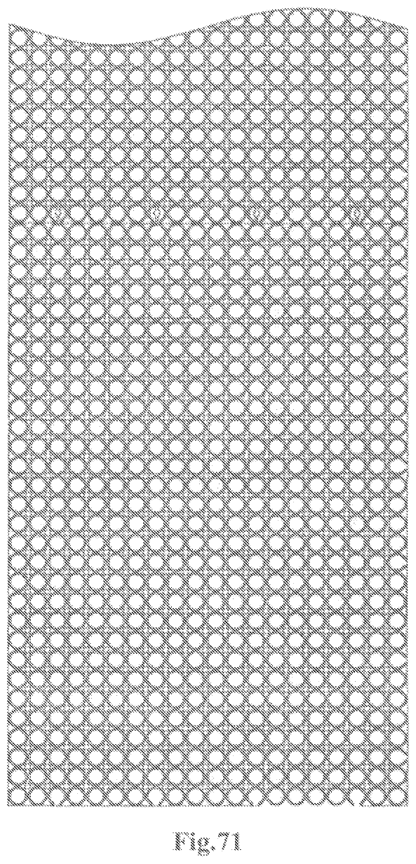

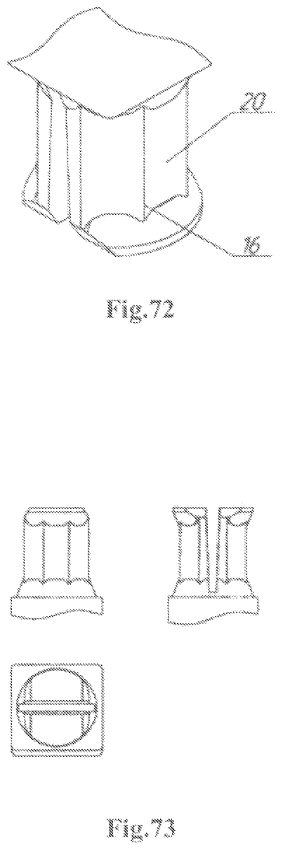

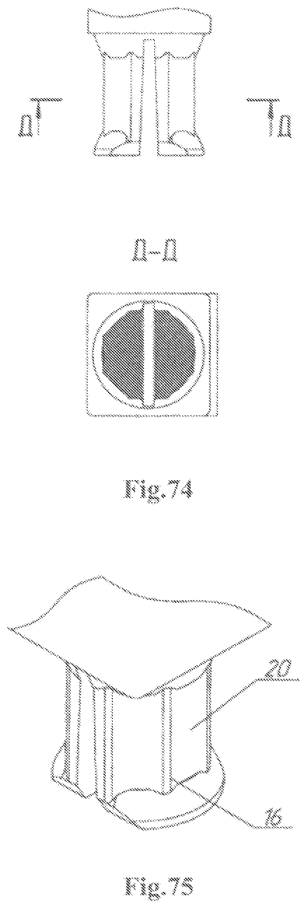

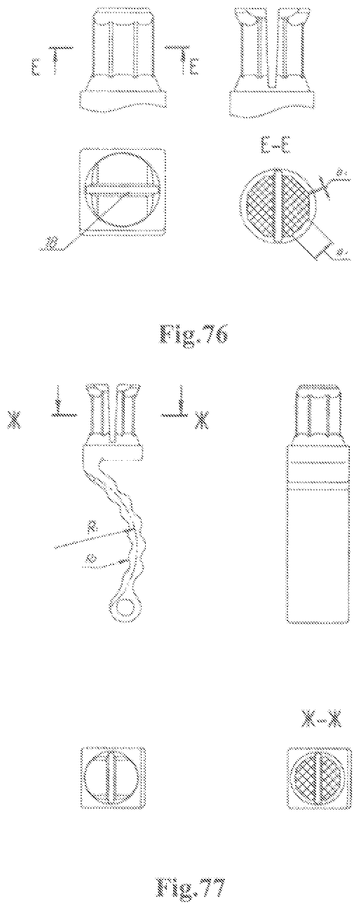

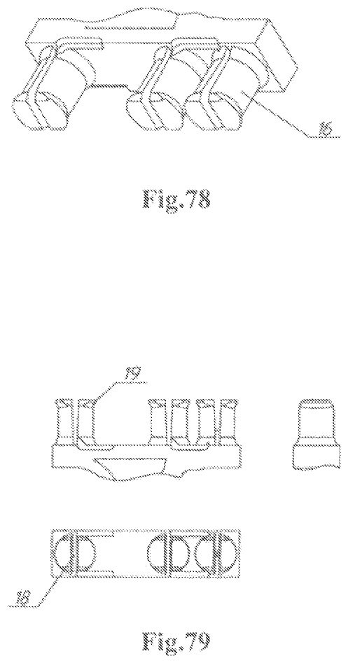

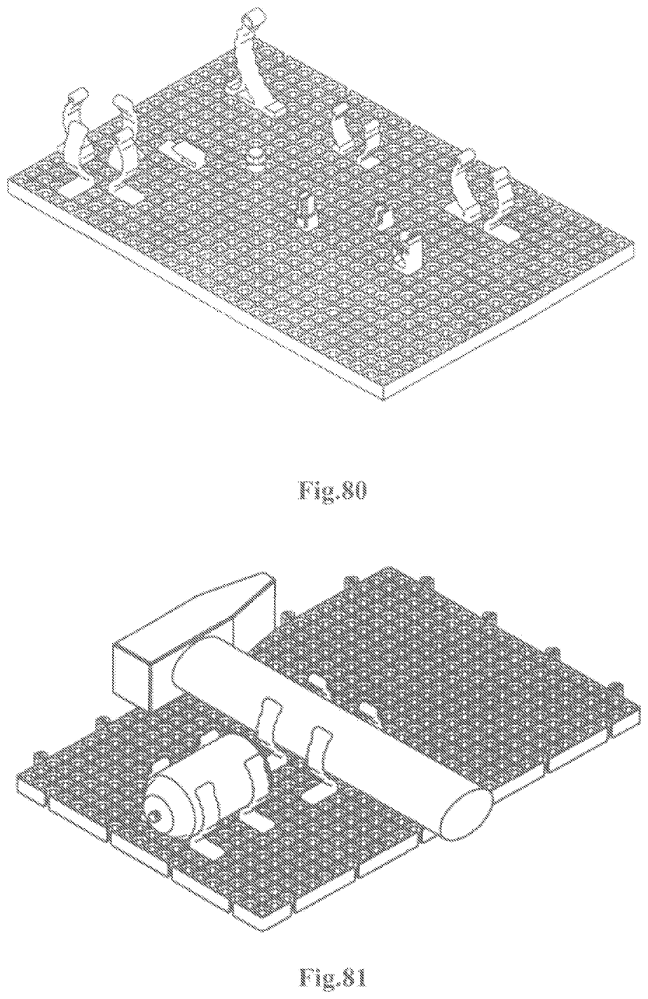

In multifaceted through-holes in the panel, facets n are required so that the holder shank does not spin. With a different number of facets n, divisible by 4 and more than 8, adjacent facets a and b have different width, which is confirmed by various examples of multifaceted through-holes (FIG. 19-68):
a>b with n=12;
examples with D=6 mm, with b=0.1 mm, a=2.91 mm
examples with D=8 mm, with b=0.1 mm, a=3.91 mm
examples with D=10 mm, with b=0.1 mm, a=4.91 mm
a>b with n=16, with D within 6-10 mm, with b=0.1 mm:
examples with D=8 mm, with b=0.1 mm, a=2.98 mm
a>b with n=24, with D within 6-10 mm, with b=0.1 mm;
examples with D=8 mm, with b=0.1 mm, a=1.97 mm
a>b with n=32, with D within 6-10 mm, with b=0.1 mm;
examples with D=8 mm, with b=0.1 mm, a=1.46 mm
a>b with n=64, with D within 6-10 mm, with b=0.1 mm;
=8 mm, with b=0.1 mm, a=0.68 mm
a>b with n=128, with D within 6-10 mm, with b=0.1 mm;
=6 mm, with b=0.1 mm, a=0.19 mm
examples with D=8 mm, with b=0.1 mm, a=0.29 mm
examples with D=10 mm, with b=0.1 mm, a=0.39 mm
a>b with n=12, with D within 6-10 mm, with b=0.3 mm;
examples with D=8 mm, with b=0.3 mm, a=3.74 mm
a>b with n=16, with D within 6-10 mm, with b=0.3 mm;
examples with D=8 mm, with b=0.3 mm, a=2.78 mm
a>b with n=24, with D within 6-10 mm, with b=0.3 mm;
examples with D=8 mm, with b=0.3 mm, a=1.78 mm
a>b with n=32, with D within 6-10 mm, with b=0.3 mm;
examples with D=8 mm, with b=0.3 mm, a=1.27 mm
a>b with n=64, with D within 6-10 mm, with b=0.3 mm;
examples with D=6 mm, with b=0.3 mm, a=0.31 mm
examples with D=8 mm, with b=0.3 mm, a=0.49 mm
examples with D=10 mm, with b=0.3 mm, a=0.68 mm
a>b with n=128, with D within 8-10 mm, with b=0.3 mm;
examples with D=6 mm, with b=0.3 mm, a=0.009 mm
examples with D=8 mm, with b=0.3 mm, a=0.09 mm
examples with D=10 mm, with b=0.3 mm, a=0.19 mm
a>b with n=12 6-10 mm, with b=0.5 mm;
examples with D=8 mm, with b=0.5 mm, a=3.57 mm
a>b with n=16, with D within 6-10 mm, with b=0.5 mm;
examples with D=8 mm, with b=0.5 mm, a=2.6 mm
a>b with n=24 (with D within 6-10 mm), with b=0.5 mm;
examples with D=8 mm, a=1.59 mm
a>b with n=32, with D within 6-10 mm, with b=0.5 mm;
examples with D=6 mm, with b=0.5 mm, a=0.68 mm
examples with D=8 mm, with b=0.5 mm, a=1.07 mm
examples with D=10 mm, with b=0.5 mm, a=1.46 mm
a>b with n=64, with D within 6-10 mm, with b=0.5 mm;
examples with D=6 mm, with b=0.5 mm, a=0.09 mm
examples with D=8 mm, with b=0.5 mm, a=0.29 mm
examples with D=10 mm, with b=0.5 mm, a=0.48 mm.

The panel is operational with various dimensions indicated above. In the positioning panel:
adjacent facets a and b of multifaceted through-holes meet the condition a>b with b=0.1 mm, with the number of facets n within 12-128, with diameter D of multifaceted through-holes within 6-10 mm;
adjacent facets a and b of multifaceted through-holes meet the condition a>b with b=0.5 mm, with n within 2-32, with D within 6-10 mm;
adjacent facets a and b of multifaceted through-holes meet the condition a≤b with b=0.3 mm, with the number of facets n=128, with D=6-10 mm;
adjacent facets a and b of multifaceted through-holes meet the condition a≤b with b=0.5 mm, with the number of facets n=64, with D=6-10 mm.

In the proposed technical solution, the number of degrees of freedom is greater in comparison with the prior art, so the panel is more functional.

The slope angle of upper and lower chamfers α and β is an angle between the plane perpendicular to the top and bottom surface of the panel, and the chamfer plane, ranging within (20-50)° (FIG. 5-6).

According to the fundamentals of human factor engineering, the characteristics of control movements of human hands have been studied, taking into account the development of motor skills (ru.wikipedia.org>wiki/ [symbol] ). (B. A. Dushkov Fundamentals of Human Factor Engineering. P. 63) (Dictionary. 3rd Ed. Publisher: Academic Project, Business Book. Series: Gaudeamus. Year: 2005. Number of pages: 848. ISBN: 5-8291-0297-8, 5-82910506-3, 5-902357-25-X.) The dictionary includes over 1200 entries which define and reveal the content of terms and concepts of human factor engineering, occupational psychology, etc.

According to the above dictionary, force characteristics are determined by force F developed in the process of movement. The most important of them is the force of hands, determined by the nature of movement and the angle between the shoulder and the sagittal axis of the body (Table 1). The maximum values Fmax indicated in Table 1 should be used for one-time application of forces. The allowable values should be used for occasional application of forces. With frequent application of forces within a long time, their values should not exceed 10-15% of the maximum values given in Table 1. The reviewed force characteristics change with the age of a person, reaching the maximum at the age of 28-30.

TABLE 1
Forces produced by person's hands, N

| | | Hand position relative to the sagittal axis of the body | | | | | | | | | |
|---|---|---|---|---|---|---|---|---|---|---|---|
| Nature and | | 1 | | 2 | | 3 | | 4 | | 5 | |
| direction of | | 180° | | 150″ | | 120″ | | 90″ | | 60° | |
| movement | Hand | Fopt | Fmax | Fopt | Fmax | Fopt | Fmax | Fopt | Fmax | Fopt | Fmax |
| Drawing | right | 216 | 540 | 236 | 530 | 168 | 468 | 148 | 396 | 96 | 380 |
| (towards | left | 196 | 520 | 168 | 500 | 130 | 426 | 126 | 359 | 102 | 288 |
| one's body) | | | | | | | | | | | |
| Pushing | right | 196 | 620 | 168 | 558 | 142 | 466 | 140 | 388 | 131 | 418 |
| (away from | left | 167 | 570 | 118 | 500 | 100 | 446 | 88 | 378 | 89 | 359 |
| one's body) | | | | | | | | | | | |
| Drawing | right | 54 | 192 | 69 | 249 | 92 | 268 | 76 | 250 | 79 | 219 |
| (up) | left | 34 | 182 | 59 | 238 | 68 | 240 | 68 | 236 | 59 | 198 |
| Pushing | right | 69 | 188 | 78 | 209 | 100 | 260 | 101 | 238 | 78 | 230 |
| (down) | left | 49 | 156 | 68 | 189 | 82 | 228 | 82 | 220 | 68 | 209 |
| Moving away | right | 54 | 150 | 58 | 148 | 58 | 150 | 62 | 166 | 68 | 188 |
| (away from | left | 31 | 138 | 29 | 129 | 38 | 138 | 39 | 146 | 29 | 142 |
| one's body) | | | | | | | | | | | |
| Moving towards | right | 78 | 226 | 78 | 239 | 88 | 236 | 68 | 226 | 79 | 238 |
| (towards | left | 49 | 192 | 58 | 209 | 78 | 200 | 62 | 216 | 68 | 228 |
| one's body) | | | | | | | | | | | |

The experiment showed the forces required to insert/remove the holder shank into/from the multifaceted through-hole as shown in Table 2.

TABLE 2
Forces produced by human hands, N, when
inserting and removing the holder shank

| Chamfer slope angle | Force for the holder (N) | |
|---|---|---|
| α and β | INSERTING the holder | removing the holder |
| 19° | 27.44 | 29.4 |
| 20° | 31.36 | 39.2 |
| 24° | 39.2 | 78.4 |
| 50° | 117.6 | 156.8 |
| 51° | 147 | 196 |

When chamfer slope angle (or bevel angle) α and β is 19°, the holder shank is inserted with a force of 2.8 kg*9.8 N/kg=27.44 N. At this chamfer slope angle, it is removed with a force of 3 kg*9.8 N/kg=29.4 N. But at this angle the holder shank is also easy to remove. In other words, the holder shank is loosely fastened in the panel, developing a backlash. This is unacceptable for fastening tools in the panel. With increase in chamfer slope angle α and β, the conicity of the multifaceted through-hole grows unduly, the holder shank develops a backlash, i.e. the holder shank begins to move loosely, practically starting to wobble in the faceted through-hole.

With a 20° chamfer slope angle, the holder shank is inserted with a force of 3.2 kg*9.8 N/kg=31.36 N. This is a norm according to the line “pushing away from one's body” and column 3 in standards Table 1. This line indicates the optimal force of 142 N. The experimentally measured force of 31.36 N to remove the holder shank does not exceed the optimal force of 142 N in the table.

And at this chamfer slope angle, it is removed with a force of 4 kg*9.8 N/kg=39.2 N. This is a norm according to the line “drawing away from one's body” and column 3 in standards Table 1. This line indicates the optimal force of 168 N. The experimentally measured force of 39.2 N to remove the holder shank does not exceed the optimal force of 168 N in the table.

In case of a double-shank holder, the force is distributed evenly over two shanks.

The holder shank is fixed in multifaceted through-hole 4 of panel 1 with a click.

With a 24° chamfer slope angle, the holder shank is inserted into the multifaceted through-hole of the panel with a force of 4 kg*9.8 N/kg=39.2 N. This is a norm according to the line “pushing away from one's body” and column 3 in standards Table 1. This line indicates the optimal force of 142 N. The experimentally measured force of 39.2 N to remove holder shank 16 from panel 1 does not exceed the optimal force of 142 N in the table.

With such a chamfer slope angle, the shank is removed from multifaceted through-hole 4 with a force of 8 kg*9.8 N/kg=78.4 N. This is a norm according to the line “drawing away from one's body” and column 3 in standards Table 1. This line indicates the optimal force of 168 N. The experimentally measured force of 78.4 N to remove holder shank 16 from multifaceted through-hole 4 of panel 1 does not exceed the optimal force of 168 N in the table.

With a 50° chamfer slope angle, shank 16 is inserted into multifaceted through-hole 4 of panel 1 with a force of: 12 kg*9.8 N/kg=117.6 N. This is a norm according to the line “pushing away from one's body” and column 3 in standards Table 1. This line indicates the optimal force of 142 N. The experimentally measured force of 117.6 N to insert the holder shank does not exceed the optimal force of 142 N in the table.

And shank 16 is removed from multifaceted through-hole 4 of panel 1 with a greater force: 16 kg*9.8 N/kg=156.8 N. This is a norm according to the line “drawing away from one's body” and column 3 in standards Table 1. This line indicates the optimal force of 168 N. The experimentally measured force of 156.8 N to remove the holder shank does not exceed the optimal force of 168 N in the table.

According to the above experiment, with a 51° chamfer slope angle, holder shank 16 is inserted into multifaceted through-hole 4 of panel 1 with a force of 15 kg*9.8 N/kg=147 N. This is not a norm according to the line “pushing away from one's body” and column 3 in standards Table 1. This line indicates the optimal force of 142 N. The experimentally measured force of 147 N to remove the holder shank exceeds the optimal force of 142 N in the table.

And shank 16 is removed from multifaceted through-hole 4 of panel 1 with a greater force: 20 kg*9.8 N/kg=196 N. This is not a norm according to the line “drawing towards one's body” and column 3 in standards Table 1. This line indicates the optimal force of 168 N. The experimentally measured force of 196 N to remove the holder shank significantly exceeds (by 28 N) the optimal force of 168 N in the table.

It is uncomfortable to use the panel with such a chamfer slope angle. With a 51° chamfer slope angle, the panel cannot function as intended. Even for a strong person, it is hard to insert and remove the holder without any additional tool (hammer), since it may cause pain to in the fingers.

Thus, optimal performance of the panel starts with a chamfer slope angle of 20°. Panels with such chamfer slope angles are suitable for people with low force, for example, children, who will use the panel to fasten lighter items such as stationery, school supplies, etc. (only small and light tools up to 1 kg can be held).

Therefore, a chamfer slope angle of 20° to 50° in the faceted through-holes, together with other features, ensures improved usability and functionality of the positioning panel. A chamfer slope angle of 20° to 50° in the faceted through-holes reduces the force required to install different types of holder shanks, thereby enabling manual installation without using any additional tools, such as pliers or a hammer.

The chamfers affect the required insertion and removal forces.

Facet slope angle γ (gamma) is an angle between the plane of the multifaceted through-hole facet and the plane perpendicular to top surface 2 and bottom surface 3 of panel 1. Facets a and b of multifaceted through-holes 4 have slope angle γ of each facet for an easier insertion, entry of the (lock) holder into the panel. It is facet slope angle γ of 0.1 to 4° of the multifaceted through-hole that ensures the panel functionality. When entering the multifaceted through-hole, the shank initially passes a chamfer with a slope angle of 20-50°, then it begins to pass the facets of faceted through-holes. Facet slope angle γ ranges within (0.1-4°). The limits of (0.1-4°) of facet slope angle γ have been determined in the course of experiment.

When facet slope angle γ is less than 0.1° of larger multifaceted through-holes, the panel fails to function as intended, since a force of more than 9 kg*9.8 N=88.2 N is required. When facet slope angle γ is less than 0.1°, the holder shank head can enter with such a great force that the holder shank has to be inserted using a hammer or the holder would not enter at all.

At the same time, the wear of the inner surface of multifaceted through-holes increases with repeated removals and insertions of the holder shank, the edge forming the lower chamber is ground off and worn out. This edge grinding off results in a decrease in the surface area of the lower conical cylinder which participates in the engagement and fixation of the shank in (the base of) the panel. Also, ledges of the holder shank (stem) are worn out because the shank rubs against the hole walls with a greater frictional force.

With increase in facet slope angle γ, the force decreases because a lead-in cone appears. With increase in facet slope angle γ>4°, i.e. more than four degrees, for example, γ=5°, γ=6°, the conicity of the multifaceted through-hole grows unduly. As a result, the holder shank develops a backlash, i.e. the holder shank begins to move loosely, practically starting to wobble in the faceted through-hole.

Thus, the above distinctive features of the current invention, in contrast to the prior art, improve the functionality of proposed panel 1.

To achieve the above technical result, the positioning panel in the specified embodiment has alternating rows of multifaceted through-holes in the panel with conical through-holes. The positioning panel is made of ABS plastic. There are 600 multifaceted through-holes in the panel, with 551 conical through-holes between them. The panel size is 300*200 mm. The smaller conical through-holes have a diameter of 3 mm (no more than 3.5 mm). The multifaceted through-hole requires facets so that the holder shank does not spin.

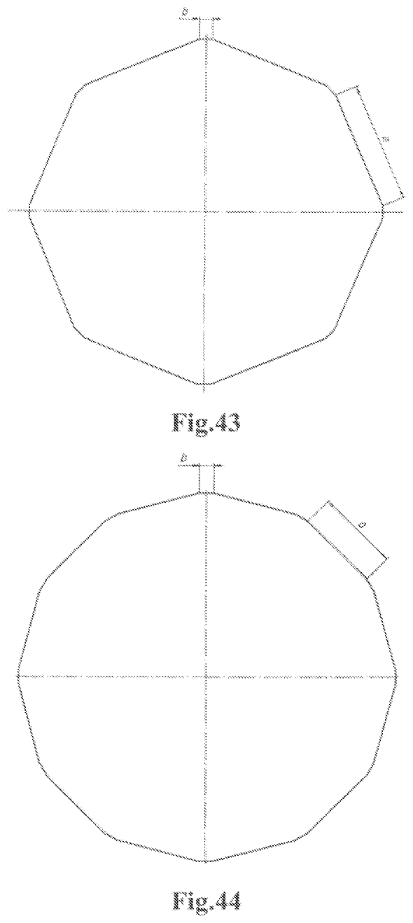

The multifaceted through-holes in the panel have 16 facets, with wider facet a=2.78 mm, smaller—narrow facet b=0.3 mm (FIG. 43). Adjacent facets a and b of multifaceted through-holes meet the condition a>b, i.e. the adjacent facets have different width, wider facet a is no more than 4.91 mm wide and smaller facet b is no more than 0.3 mm wide. Chamfer slope angle is α=β=24° with a chamfer depth of 2.2 mm. Facet slope angle is γ=2° (i.e. within))(0.1-4°.

The hole diameter of the inner cylinder formed by wide facets along the planes is 7.51 mm, the hole diameter of the inner cylinder formed by narrow facets along the planes is 8 mm, the upper edge diameter of the hole chamfer is 9.96 mm.

In this case, the smaller facets can have a concave radius of at least 0.01 mm, depending on material quality and plasticity.

Between the multifaceted through-holes there are conical through-holes with a diameter of 2.3 mm, widening towards the base; the diameter of the conical through-holes at the base is 2.9 mm.

In this case, the smaller facets can have a concave radius, for example, 0.03 mm (i.e. at least 0.01 mm), depending on material quality and plasticity. Making the smaller facets with a concave radius of at least 0.01 mm allows easier positioning of shanks in the panel, which improves the functionality of the positioning panel.

In this case, the wide facet of through-holes is less than or equal to 4.91 mm, the short facet is less than or equal to 0.3 mm. If the smaller (narrow) facet is increased to be more than 0.5 mm, the wide edge shall be reduced. This is required to maintain the diameter of the to large through-hole within 6-10 mm.

The combination of all these features allows to improve the functionality and usability of the positioning panel in comparison with its closest analog: the proposed design of panel 1 provides the installation of holders 15 with one shank 16 on panel 1 in 64 positions (at 22.5°—16 positions, at 11.25°—32 positions, at 5.625°—64 positions) in contrast to the prior art. In the prior art, holders 15 with one shank 16 could be installed on panel 1 only in eight positions.

What is claimed is:

1. A positioning panel for fixing items, which contains a top surface (front) and a bottom surface (base) with a number of multifaceted through-holes in a panel body; opposite facets of multifaceted through-holes are equal, and multifaceted through-holes are arranged in rows in the panel body; there are chamfers on the top and bottom surfaces of the panel at a location of multifaceted through-holes, differs in that a number of facets n is multiple of four, but more than eight, and adjacent facets have different width, and a chamfer slope angle, i.e. an angle between the plane perpendicular to the top and bottom surfaces of the panel, and a chamfer plane, is within (20-50°), and a facet slope angle, i.e. an angle between a plane perpendicular to the top and bottom surfaces of the panel, and a plane of the multifaceted through-hole facet, is within (0.1-4°); and an inner surface of the multifaceted through-holes narrows towards the base; and the panel contains conical through-holes smaller than the multifaceted through-holes; and the multifaceted through-holes alternate with the smaller conical through-holes, subject to a condition of 2≤S≤14 mm, where S is a minimum distance between the multifaceted through-holes, measured along the top front surface of the panel.

2. The positioning panel according to claim 1, differs in that one of adjacent facets a is no more than 4.91 mm wide, and other facet b is no more than 0.3 mm wide.

3. The positioning panel according to claim 1, differs in that the multifaceted through-holes have a pitch L within (8-20) mm, where pitch L is a distance between centers of the multifaceted through-holes.

4. The positioning panel according to claim 1, differs in that the multifaceted through-holes on the top front surface of the panel have diameter D within (6-10) mm, where D is a diameter of a circumscribing circle along vertices of a polygon formed by facets of the multifaceted through-hole at points where the chamfer on the front top surface of the panel interfaces with facets of the multifaceted through-hole.

5. The positioning panel according to claim 1, differs in that the smaller facets of the inner surface of the multifaceted through-holes can be concave or corners in the multifaceted through-hole can be rounded.

6. The positioning panel according to claim 1, differs in that the smaller facets of the inner surface of the multifaceted through-holes can be concave with a radius of rounding of no less than 0.1 mm.

7. The positioning panel according to claim 1, differs in that the smaller conical through-holes widen towards the base.

8. The positioning panel according to claim 4, differs in that the conical through-holes have a diameter of no more than 3.5 mm.

9. The positioning panel according to claim 1, differs in that it is made of ABS plastic.
